(19) United States
(12) Patent Application Publication
(10) Pub. No.: US 2005/0207016 A1
(43) Pub. Date: Sep. 22, 2005

(54) Antireflection film, polarizing plate and liquid crystal display

(75) Inventor: Takumi Ando, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/079,875

(22) Filed: Mar. 15, 2005

(30) Foreign Application Priority Data
Mar. 15, 2004 (JP) 2004-072929

(51) Int. Cl. G02B 1/10

(52) U.S. Cl. 359/586; 359/580; 359/599

(57) ABSTRACT

An antireflection film comprising: a first transparent support; a low refractive index layer as an outermost layer; and a hard coat layer between the first transparent support and the low refractive index layer, wherein (i) the hard coat layer comprises a binder and light-transmitting particles, in which the binder and the light-transmitting particles have different refractive indexes; (ii) the antireflection film has a centerline average roughness (Ra) of not more than 0.10 μm; and (iii) the low refractive index layer comprises hollow silica fine particles having an average particle size of 5 to 200 nm and a refractive index of 1.15 to 1.40; a polarizing plate using this antireflection film in a one-sided protective film; and a liquid crystal display using the foregoing antireflection film or polarizing plate in the most superficial layer.

### BACKGROUND OF THE INVENTION

1. Field of the Invention

The present invention relates to a display element to be used for image displays in computers, word processors, television sets, and so on, and in particular, an antireflection film for designing to enhance the display grade; a polarizing plate; and a liquid crystal display.

2. Description of the Related Art

In general, an antireflection film is aligned in the most superficial surface of a display such as a cathode ray tube display (CRT), a plasma display panel (PDP), an electroluminescence display (ELD), and a liquid crystal display (LCD) while utilizing the principles of light diffusion and optical interference for the purposes of preventing a lowering of the contrast or image glare caused by reflection of external light and enhancing the visibility of image.

As related antireflection films, there are antidazzle antireflection films of suppressing specular reflection of external light and preventing glare of an external circumference by diffusing the surface reflected light. For example, in an antireflection film of JP-A-2000-338310, a proper fine particle is contained in a hard coat layer to impart irregularities on the surface, thereby diffusing external light to relieve dazzling of the screen. Also, in antireflection films of JP-A-2002-196117 and JP-A-2003-161816, one low refractive index layer is provided on an antidazzle hard coat having a surface fine irregular shape, thereby diffusing external light and suppressing a reflectance utilizing the principles of optical interference. Further, in an antireflection film of JP-A-2003-121620, a high refractive index layer is provided beneath a low refractive index layer, thereby reducing the reflection of external light effectively utilizing optical interference.

However, these antidazzle antireflection films are unavoidable from such problems that at the same time when the external light is diffused by the fine irregularities on the surface, the display screen becomes white (white blurring); that the definition of an image is lowered (the image is blurred); that a glaring phenomenon occurs due to a lens effect of the fine irregular structure. Against these problems, improvements were tried by controlling the haze of an antidazzle layer, the definition of an image, or the fine irregular shape, but satisfactory levels have not been obtained yet.

On the other hand, with respect to an antireflection film which has high definition of an image and which is free from a white blurring or glaring phenomenon, antireflection films having very small surface fine irregularities or having a smooth surface have been proposed. JP-A-2003-75603 proposes an antireflection film utilizing only optical interference, in which a laminate structure of a substrate film having thereon a medium refractive index layer, a high refractive index layer, and a low refractive index layer in this order, and which is free from a surface fine irregular structure. Also, JP-A-2002-317152 proposes an antireflection film in which while keeping the surface roughness very small, internal scattering properties are imparted in a hard coat layer, whereby not only a sharp image is realized, but also viewing angle characteristics can be improved. However, in all of these proposed antireflection films, the refractive index of the low refractive index layer as the outermost surface is not so low, and satisfactory levels have not been obtained yet with respect to the visibility in a daylight room.

Also, there has been made a trial to enhance the antireflection performance by lowering the refractive index of a low refractive index layer as the outermost surface. So far, for the purpose of lowering the refractive index of a layer, there have been made measures for increasing the fluorine content of a material to be used or introducing voids to lower the density within the layer. However, all of these measures have caused such a problem that the film strength and the adhesion to a lower layer are impaired so that the abrasion resistance is lowered. Then, JP-A-2003-57415 proposes an antireflection film in which a low refractFFive index layer containing a hollow silica fine particle is provided on a hard coat layer having a smooth surface, which does not contain a particle at all, whereby not only the antireflection properties are improved by an effect of the hollow silica for lowering the refractive index, but also the film strength is improved by the strength of the hollow silica.

However, in recent years, the circumference where a variety of displays are used includes many fields. Also, requirements in higher levels are made with respect to the display grade. Although improving effects are observed to some extent regarding the prevention of glare of external light and the abrasion resistance, it is hard to say that in addition to these performances, high levels can be attained at the same time from the standpoints of definition of the image and viewing angle characteristics.

### SUMMARY OF THE INVENTION

An object of the invention is to provide an antireflection film which is prevented from glare of external light, is free from white blurring, image blurring and glaring phenomena and is improved with respect to the abrasion resistance for the purpose of enhancing the visibility of displays such as liquid crystal displays.

Another object of the invention is to provide a polarizing plate which has high visibility by an antireflection film and enlarges a viewing angle (in particular, a downward viewing angle) so that a lowering of the contrast and changes in gradation, black-and-white reversion, hue, etc. caused by the change of viewing angle do not substantially occur, and a liquid crystal display using the same.

The foregoing objects of the invention are attained by antireflection films set forth in the following items 1 to 10, polarizing plates set forth in the following items 11 to 15, and a liquid crystal display set forth in the following item 16.

(1) An antireflection film comprising:

a first transparent support;

a low refractive index layer as an outermost layer; and

a hard coat layer between the first transparent support and the low refractive index layer,

wherein (i) the hard coat layer comprises a binder and light-transmitting particles, in which the binder and the light-transmitting particles have different refractive indexes;

(ii) the antireflection film has a centerline average roughness (Ra) of not more than 0.10 μm; and

(iii) the low refractive index layer comprises hollow silica fine particles having an average particle size of 5 to 200 rn and a refractive index of 1.15 to 1.40.

(2) The antireflection film as described in (1) above,

wherein at least one of the hard coat layer and the low refractive index layer comprises at least one of a hydrolysate of an organo silane compound and a partial condensate of an organo silane compound.

(3) The antireflection film as described in (1) or (2) above, which has a transmitted image clarity of 60% or more.

(4) The antireflection film as described in any of (1) to (3) above, which has a haze of 10% or more.

(5) The antireflection film as described in any of (1) to (4) above,

wherein die hard coat layer has a ratio of an intensity of a scattered light having an outgoing angle of 30° with respect to an intensity of a light having an outgoing angle of 0° in a scattered light profile measured by a goniophotometer, of from 0.01% to 0.2%.

(6) The antireflection film as described in any of (1) to (5) above, which has a mean integrated reflectance of not more than 1.5% in a wavelength of from 450 to 650 nm.

(7) The antireflection film as described in any of (1) to (6) above, which further comprises a high refractive index layer between the hard coat layer and the low refractive index layer,

wherein the high refractive index layer has a higher refractive index than the first transparent support.

(8) The antireflection film as described in (7) above, which further comprises a medium refractive index layer between the hard coat layer and the low refractive index layer,

wherein the medium refractive index layer has a higher refractive index than the low refractive index layer, and has a lower refractive index than the high refractive index layer,

wherein the medium refractive index layer has a higher refractive index than the first transparent support.

(9) The antireflection film as described in (8) above, which comprises the first transparent support; the hard coat layer; the medium refractive index layer; the high refractive index layer; and the low refractive index layer, in this order.

(10) A polarizing plate comprising:

a first protective film;

a second protective film; and

a polarizing film between the first protective film and the second protective film,

wherein the first protective film is an antireflection film as described in any of (1) to (10) above.

(11) The polarizing plate as described in (10) above,

wherein the first transparent support of the antireflection film is between the polarizing film and the low refractive index layer of the antireflection film.

(12) The polarizing plate as described in (10) or (11) above,

wherein the second protective film is an optical compensating film comprising:

a second transparent support; and

an optically anisotropic layer including a compound having a discotic structure unit,

wherein the discotic structure unit has a disc plane slanted to a plane of the second transparent support, and an angle between the disc plane and the plane of the second transparent support varies in a depth direction of the optically anisotropic layer.

(13) The polarizing plate as described in (12) above,

wherein the second transparent support is between the polarizing film and the optically anisotropic layer.

(14) A liquid crystal display comprising an antireflection film as described in (1) to (9) above or a polarizing plate as described in (10) to (13) above in the most superficial layer of the liquid crystal display.

### BRIEF DESCRIPTION OF THE DRAWINGS

FIG. 1 shows a schematic show cross-sectional view of a construction example of the antireflection film of the invention;

FIG. 2 shows a schematic show cross-sectional view of a construction example of the antireflection film of the invention; and

FIG. 3 shows a schematic show cross-sectional view of a construction example of the antireflection film of the invention.

### DETAILED DESCRIPTION OF THE INVENTION

First of all, embodiments of the antireflection film of the invention will be described below with reference to the drawings.

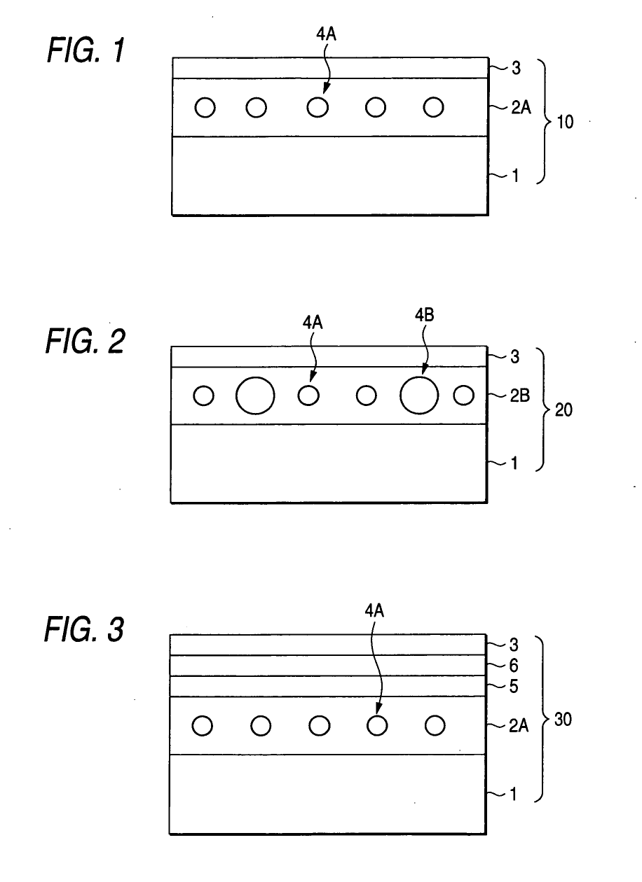

FIGS. 1 to 3 each schematically shows a cross-sectional view of a construction example of the antireflection film of the invention. As shown in FIG. 1, an antireflection film 10 of the invention is composed of a laminate of a transparent support 1, a hard coat layer 2A containing a light-transmitting particle 4A capable of imparting internal scattering properties, and a low refractive index layer 3 containing a hollow silica fine particle as the outermost layer. An embodiment of each layer and a layer construction of the film can be properly changed. For example, as shown in an antireflection film 20 of FIG. 2, a hard coat layer 2B may further contain a light-transmitting particle 4B of other kind therein. As shown in an antireflection film 30 of FIG. 3, for the purpose of enhancing antireflection properties by optical interference, a medium refractive index layer 5 and a high refractive index layer 6 may be provided on the hard coat layer 2A, while aligning the low refractive layer 3 as the outermost layer.

Next, the respective layers constructing the antireflection film of the invention will be described below in detail.

Transparent Support

The transparent support of the antireflection film of the invention is not particularly limited, and examples thereof include transparent resin films, transparent resin plates, transparent resin sheets, and transparent glasses. As the transparent resin films, cellulose acylate films (for example, cellulose triacetate films (refractive index: 1.48), cellulose diacetate films, cellulose acetate butyrate films, and cellulose acetate propionate films), polyethylene terephthalate films, polyether sulfone films, polyacrylic based resin films, polyurethane based resin films, polyester films, polycarbonate films, polysulfone films, polyether films, polymethylpentene films, polyether ketone films, (meth)acrylonitrile films, and the like can be used.

Of these, cellulose acylate films which have high transparency, are optically small with respect to birefringence, are easy for manufacturing, and are generally used as a protective film of a polarizing plate are preferable, and cellulose triacetate films are especially preferable. Also, the thickness of the transparent support is usually from about 25 μm to 1,000 μm.

For the cellulose acylate film of the invention, it is preferred to use cellulose acetate having a degree of acetylation of from 59.0 to 61.5%.

The term “degree of acetylation” as referred to herein means the content of bound acetic acid per unit weight of cellulose. The degree of acetylation follows the measurement and calculation of the acetylation degree in ASTM: D-817-91 (test method of cellulose acetate, etc.).

The viscosity average degree of polymerization (DP) of the cellulose acylate is preferably 250 or more, and more preferably 290 or more.

Also, in the cellulose acylate to be used in the invention, it is preferable that a value of Mw/Mn (wherein Mw represents a weight average molecular weight, and Mn represents a number average molecular weight) according to the gel permeation chromatography is closed to 1.0, in another word, the molecular weight distribution is narrow. Specifically, the Mw/Mn value is preferably from 1.0 to 1.7, more preferably from 1.3 to 1.65, and most preferably from 1.4 to 1.6.

In general, the hydroxyl groups at the 2-, 3- and 6-positions of the cellulose acylate are not equally distributed at every ⅓ of the degree of substitution of the whole, but the degree of substitution of the hydroxyl group at the 6-position tends to become small. In the invention, it is preferable that the degree of substitution of the hydroxyl group at the 6-position of the cellulose acylate is larger than that at the 2- or 3-position.

The hydroxyl group at the 6-position is preferably substituted with an acyl group in a proportion of 32% or more, more preferably 33% or more, and especially preferably 34% or more with respect to the degree of substitution of the whole. Further, it is preferable that the degree of substitution of the acyl group at the 6-position of the cellulose acylate is 0.88 or more. The hydroxyl group at the 6-position may be substituted with an acyl group having 3 or more carbon atoms other than the acetyl group, such as a propionyl group, a butyroyl group, a valeroyl group, a benzoyl group, and an acryloyl group. The degree of substitution at each position can be measured and determined by NMR.

As the cellulose acylate of the invention, cellulose acetates obtained by the methods described in [Synthetic Example 1] of [Examples] of paragraphs [0043] to [0044], [Synthetic Example 2] of paragraphs [0048] to [0049] and [Synthetic Example 3] of paragraphs [0051] to [0052] of JP-A-11-5851 can be used.

Production of Cellulose Acylate Film

The cellulose acylate film of the invention can be produced by the solvent cast method. According to the solvent cast method, the film is produced using a solution (dope) having a cellulose acylate dissolved in an organic solvent.

It is preferable that the organic solvent contains a solvent selected from ethers having from 3 to 12 carbon atoms, ketones having from 3 to 12 carbon atoms, esters having from 3 to 12 carbon atoms, and halogenated hydrocarbons having from 1 to 6 carbon atoms. Mixtures of two or more kinds of organic solvents may be used.

The ethers, ketones and esters may have a cyclic structure. Compounds having two or more of any of functional groups of ethers, ketones and esters (that is, —O—, —CO—, and —COO—) can also be used as the organic solvent. The organic solvent may have other functional group such as an alcoholic hydroxyl group. In the case of an organic solvent having two or more kinds of functional groups, its preferred carbon atom number may fall within the range of the preferred carbon atom number as specified above for compounds having any one of functional groups.

Examples of the ethers having from 3 to 12 carbon atoms include diisopropyl ether, dimethoxymethane, dimethoxyethane, 1,4-dioxane, 1,3-dioxolan, tetrahydrofuran, amisole, and phenetole.

Examples of the ketones having from 3 to 12 carbon atoms include acetone, methyl ethyl ketone, diethyl ketone, diisobutyl ketone, cyclohexanone, and methylcyclohexanone.

Examples of the esters having from 3 to 12 carbon atoms include ethyl formate, propyl formate, pentyl formate, methyl acetate, ethyl acetate, and pentyl acetate.

Examples of the organic solvents having two or more kinds of functional groups include 2-ethoxyethyl acetate, 2-methoxyethanol, and 2-butoxyethanol.

The carbon atom number of the halogenated hydrocarbon is preferably 1 or 2, and most preferably 1. The halogen of the halogenated hydrocarbon is preferably chlorine. The proportion of substitution of the hydrogen atoms of the halogenated hydrocarbon with a halogen is preferably from 25 to 75% by mole, more preferably from 30 to 70% by mole, further preferably from 35 to 65% by mole, and most preferably from 40 to 60% by mole. Methylene chloride is a representative halogenated hydrocarbon.

The preparation of the cellulose acylate solution (dope) can be carried out by a general method. The general method as referred to herein means a treatment at a temperature of 0° C. or higher (ordinary temperature or high temperatures). The preparation of the solution can be carried out using a preparation method of a dope and a device in the usual solvent cast method. Incidentally, in the case of the general method, it is preferred to use a halogenated hydrocarbon (in particular, methylene chloride) as the organic solvent. Non-chlorine based solvents can be used, too, and examples thereof include ones described in Journal of Technical Disclosure 2001-1745.

The amount of the cellulose acylate is adjusted at from 10 to 40% by weight in the resulting solution. More preferably, the amount of the cellulose acylate is from 10 to 30% by weight. Arbitrary additives as described later may be added in the organic solvent (principal solvent).

The solution can be prepared by stirring the cellulose acylate and the organic solvent at ordinary temperature (from 0 to 40° C.). A high-concentration solution may be stirred under pressure and heating conditions.

Specifically, the cellulose acylate and the organic solvent are charged and sealed in a pressure container and stirred under pressure while heating at a temperature in the range of the boiling point of the solvent at ordinary temperature or higher and at which the solvent does not boil. The heating temperature is usually 40° C. or higher, preferably from 60 to 200° C., and more preferably from 80 to 110° C.

The respective components may be coarsely mixed in advance and then charged in the container. Also, they may be successively thrown into the container. The container must be constructed in such a manner that stirring can be achieved. An inert gas such as a nitrogen gas can be poured into the container, followed by subjecting the container to pressurization. Also, a rise of the vapor pressure of the solvent by heating may be utilized. Alternatively, after sealing the container, the respective components may be added under pressure.

In the case of heating, it is preferred to externally heat the container. For example, a jacket type heating device can be used. Also, it is possible to heat the whole of the container by providing a pre-heater outside the container, piping the container and circulating a liquid.

It is preferred to provide a stirring blade in the container and perform stirring using this. As the stirring blade, one having a length reaching the vicinity of the wall of the container is preferable. It is preferred to provide a scraping blade for renewing a liquid film on the wall of the container in the tip of the stirring blade.

The container may be installed with instruments such as a pressure gauge and a thermometer. The respective components are dissolved in the solvent within the container. The prepared dope is cooled and then discharged from the container, or discharged from the container and then cooled using a heat exchanger, etc.

The solution can also be prepared by the cooling dissolution method. According to the cooling dissolution method, it is possible to dissolve the cellulose acylate in an organic solvent in which the cellulose acrylate is hardly dissolved in the usual dissolution method. Incidentally, there gives rise to an effect that even in a solvent in which cellulose acetate can be dissolved in the usual dissolution method, a uniform solution can be rapidly obtained by the cooling dissolution method.

According to the cooling dissolution method, the cellulose acylate is gradually added in the organic solvent with stirring at room temperature.

It is preferable that the amount of the cellulose acylate is adjusted at from 10 to 40% by weight in the mixture. The amount of the cellulose acylate is more preferably from 10 to 30% by weight. Further, arbitrary additives as described later may be added in the mixture.

Next, the mixture is cooled to a temperature of from −100 to −10° C. (preferably from −80 to −10° C., more preferably −50 to −20° C., and most preferably from −50 to −30° C.). The cooling can be carried out in a dry ice/methanol bath (−75° C.) or a cooled diethylene glycol solution (from −30 to −20° C.). When the mixture of cellulose acetate and the organic solvent is cooled in such a way, the mixture is solidified.

The cooling rate is preferably 4° C./min or more, more preferably 8° C./min or more, and most preferably 12° C./min or more. It is preferable that the cooling rate is as fast as possible. A cooling rate of 10,000° C./sec is a theoretical upper limit; a cooling rate of 1,000° C./sec is a technical upper limited; and a cooling rate of 100° C./sec is a practical upper limit. Incidentally, the cooling rate is a value obtained by dividing a difference between a temperature at which the cooling starts and a final cooling temperature by the time from the start of cooling until the time when the temperature reaches the final cooling temperature.

Further, when the resulting mixture is heated at from 0 to 200° C. (preferably from 0 to 150° C., more preferably from 0 to 120° C., and most preferably from 0 to 50° C.), the cellulose acetate is dissolved in the organic solvent. The temperature rising may be achieved by allowing the mixture to stand at room temperature or by heating in a warm bath.

The temperature rising rate is preferably 4° C./min or more, more preferably 8° C./min or more, and most preferably 12° C./min or more. It is preferable that the temperature rising rate is as fast as possible. A temperature rising rate of 10,000° C./sec is a theoretical upper limit; a temperature rising rate of 1,000° C./sec is a technical upper limited; and a temperature rising rate of 100° C./sec is a practical upper limit. Incidentally, the temperature rising rate is a value obtained by dividing a difference between a temperature at which the temperature rising starts and a final temperature rising temperature by the time from the start of temperature rising until the time when the temperature reaches the final temperature rising temperature.

There is thus obtained a uniform solution. Incidentally, in the case where the dissolution is insufficient, the cooling and temperature rising operation may be repeated. Whether or not the dissolution is sufficient can be judged by merely visual observation of the appearance of the solution.

In the cooling dissolution method, in order to avoid the incorporation of moisture due to dew condensation at the time of cooling, it is desired to use an airtight container. Also, in the cooling and temperature rising operation, when the pressure is elevated at the time of cooling and reduced at the time of temperature rising, it is possible to shorten the dissolution time. For the sake of carrying out the pressure elevation and the pressure reduction, it is desired to use a pressure container.

Incidentally, according to the differential scanning calorimetry (DSC), in a 20% weight solution having cellulose acetate (degree of acetylation: 60.9%, viscosity average degree of polymerization: 299) dissolved in methyl acetate by the cooling dissolution method, a pseudo phase transition point between the sol state and the gel state is present in the vicinity of 33° C., and the solution becomes in a uniform gel state below this temperature. Accordingly, it is necessary that this solution is kept at a temperature of the pseudo phase transition point or higher, and preferably at a temperature of about 10° C. higher than the gel phase transition temperature. However, this pseudo phase transition temperature varies depending upon the degree of acetylation and viscosity average degree of polymerization of cellulose acetate, the solution concentration, and the organic solvent to be used.

A cellulose acylate film is produced from the thus prepared cellulose acylate solution (dope) by the solvent cast method.

The dope is cast on a drum or a band, and the solvent is evaporated to form a film. It is preferable that the concentration of the dope before casting is adjusted such that the solids content is from 18 to 35%. It is preferable that the surface of the drum or band is finished in the mirror state. The casting and drying methods in the solvent cast method are described in U.S. Pat. Nos. 2,336,310, 2,367,603, 2,492,078, 2,492,977, 2,492,978, 2,607,704, 2,739,069 and 2,739,070, British Patent Nos. 640,731 and 736,892, JP-B-45-4554, JP-B-49-5614, and JP-B-62-115035.

It is preferable that the dope is cast on the drum or band having a surface temperature of not higher than 10° C. After casting, the dope is preferably dried while blowing air for 2 seconds or more. The resulting film is peeled off from the drum or band and further dried by high-temperature air whose temperature is successively changed from 100 to 160° C., whereby the residual solvent can be evaporated. This method is described in JP-B-5-17844. According to this method, it is possible to shorten the time from casting until peeling-off In order to carry out this method, it is necessary that the dope becomes gelled at the surface temperature of the drum or band at the time of casting.

Using plural cellulose acylate solutions (dopes) as prepared, a film can also be prepared by casting two or more layers by the solvent cast method. In this case, each of the dopes is cast on a drum or a band, and the solvent is evaporated to form a film. It is preferable that the concentration of each dope before casting is adjusted such that the solids content is from 10 to 40%. It is preferable that the surface of the drum or band is finished in the mirror state.

In the case of casting two or more layers of plural cellulose acylate solutions, it is possible to cast plural cellulose acylate solutions, and a film may be prepared by respectively casting cellulose acylate-containing solutions from plural casting nozzles provided at intervals in the delivery direction of a support while laminating. For example, the methods described in JP-A-61-158414, JP-A-1-122419, and JP-A-11-198285 can be applied. Also, a film may be formed by casting the cellulose acylate solution from two casting nozzles. For example, this can be carried out by the methods described in JP-B-60-27562, JP-A-61-94724, JP-A-61-104813, JP-A-61-158413, and JP-A-6-134933. Also, a cellulose acylate film casting method described in JP-A-56-162617, in which a flow of a high-viscosity cellulose acylate solution is enveloped by a low-viscosity cellulose acylate solution, and the high-viscosity and low-viscosity cellulose acylate solutions are simultaneously extruded, may be employed.

Alternatively, a film may be prepared by a method in which using two casting nozzles, a film formed on a support by a first casting nozzle is peeled off, and second casting is performed in the side coming into contact with the support surface. For example, this method is described in JP-B-44-20235. The cellulose acylate solutions to be cast may be the same solution or a different cellulose acylate solution, and are not particularly limited. In order to make the plural cellulose acylate layers have a function, a cellulose acylate solution adaptive to the function may be extruded from the respective casting nozzles.

Moreover, in the invention, the cellulose acylate solution is simultaneously cast together with a solution for forming other functional layer (for example, an adhesive layer, a dye layer, an antistatic layer, an anti-halation layer, a UV absorbing layer, and a polarizing layer), whereby the functional layer and the film can be formed at the same time.

In a single layer solution, for the sake of obtaining a necessary thickness, a high-viscosity cellulose acylate solution must be extruded in a high concentration. In that case, since the stability of the cellulose acylate solution is poor, there are often encountered such problems that solids are generated to cause dirt and that the flatness is poor. As a method of dissolving these problems, plural cellulose acylate solutions are cast from casting nozzles. By this method, the high-viscosity solutions can be simultaneously extruded on the support, whereby an excellent planar film having improved flatness can be prepared. Also, by using concentrated cellulose acylate solutions, a reduction of the drying load can be achieved, and a manufacturing speed of the film can be enhanced.

For the purpose of improving the mechanical physical properties or enhancing the drying speed after casting in the film production, a plasticizer can be added to the cellulose acylate film. As the plasticizer, phosphoric esters or carboxylic esters are used. Examples of the phosphoric esters include triphenyl phosphate (TPP), diphenylbiphenyl phosphate, and tricresyl phosphate (TCP). As the carboxylic esters, phthahic esters and citric esters are representative. Examples of the phthalic esters include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citric esters include triethyl o-acetylcitrate (OACTE) and tributyl o-acetylcitrate (OACTB). Example of other carboxylic esters include butyl oleate, methylacetyl ricinoleate, dibutyl sebacate, and various trimellitic esters. Of these, phthalic ester based plasticizers (for example, DMP, DEP, DBP, DOP, DPP, and DEHP) are preferable, and DEP and DPP are especially preferable.

The addition amount of the plasticizer is preferably from 0.1 to 25% by weight, more preferably from 1 to 20% by weight, and most preferably from 3 to 15% by weight based on the amount of the cellulose acylate.

A deterioration inhibitor (for example, an antioxidant, a peroxide decomposing agent, a radical inhibitor, a metal inactivating agent, an acid scavenger, and an amine) may be added to the cellulose acylate film. The deterioration inhibitor is described in JP-A-3-199201, JP-A-5-197073, JP-A-5-194789, JP-A-5-271471, and JP-A-6-107854. The addition amount of the deterioration inhibitor is preferably from 0.01 to 1% by weight, and more preferably from 0.01 to 0.2% by weight based on the amount of the solution (dope) to be prepared, while taking into consideration the effect and bleed-out of the deterioration inhibitor onto the film surface. Of these deterioration inhibitors, butylated hydroxytoluene (BHT) and tribenzylamine (TBA) are especially preferable. As to these additives, the compounds described in Japan Institute of Invention and Innovation Exhibit Technique No. 2001-1745, page 16, the bottom of right column to page 18, left column (published on Mar. 15, 2001) can be used.

For adjusting retardation of the film, a retardation increasing agent can be used in the cellulose acylate film as the need arises. As the retardation of the film, one of from 0 to 300 nm in the thickness direction and from 0 to 1,000 nm in the inplane direction is preferably used.

As the retardation increasing agent, an aromatic compound having at least two aromatic rings is preferable. The aromatic compound is used in an amount ranging from 0.01 to 20 parts by weight based on 100 parts by weight of the cellulose acylate. The aromatic compound is preferably used in an amount ranging from 0.05 to 15 parts by weight, and more preferably ranging from 0.1 to 10 parts by weight based on 100 parts by weight of the cellulose acylate. Two or more kinds of aromatic compounds may be used jointly.

The details are described in JP-A-2000-111914, JP-A-2000-275434, JP-A-2002-236215, and PCT/JP00/026 19.

Stretching Treatment of Cellulose Acylate Film

By further subjecting the thus prepared cellulose film to a stretching treatment, it is possible to improve drying unevenness, thickness unevenness caused by drying shrinkage, and surface irregularities. Also, the stretching treatment can also be used for adjusting the retardation.

The stretching treatment method in the widthwise direction is not particularly limited, and examples thereof include a stretching method by a tenter.

Also, more preferably, longitudinal stretching is carried out in the longitudinal direction of rolls. Longitudinal stretching becomes possible by adjusting a draw ratio between pass rolls for delivering a rolled film (a rotation ratio among the pass rolls).

Surface Treatment of Cellulose Acylate Film

It is preferable that the cellulose acylate film is subjected to a surface treatment. Specific examples thereof include a corona discharge treatment, a glow discharge treatment, a flame treatment, an acid treatment, an alkaline treatment, and an ultraviolet ray-irradiating treatment. Also, it is preferably utilized to provide an undercoat layer as described in JP-A-7-333433.

From the viewpoint of keeping the flatness of the film, it is preferred to set up the temperature of the cellulose acylate film at not higher than Tg, and specifically not higher than 150° C. in such a treatment.

In the case where the cellulose acylate film is made to adhere to a polarizing film as in the case of using the antireflection film of the invention as a protective film of a polarizing plate, it is especially preferred from the viewpoint of adhesiveness to the polarizing film to carry out an acid treatment or an alkaline treatment, namely, a saponification treatment with the cellulose acylate.

From the viewpoint of the adhesiveness, the surface energy of the cellulose acylate film is preferably 55 mN/m or more, and more preferably from 60 mN/m to 75 mN/m. The surface energy can be adjusted by the foregoing surface treatment.

The surface energy of a solid can be determined by a contact angle method, a wetting heat method, or an adsorption method as described in Nure No Kiso To Oyo (Foundations and Applications of Wetting) (published on Dec. 10, 1989 by Realize Co., Ltd.). In the case of the cellulose acylate film of the invention, it is preferred to employ a contact angle method.

Specifically, two kinds of solutions whose surface energies are already known are dropped on the cellulose acylate film; at a point of intersection between the surface of the droplet and the film surface, among angles made between a tangent drawn on the droplet and the film surface, an angle including the droplet is defined as the contact angle; and the surface energy of the film can be calculated by computation.

The surface treatment will be specifically described below with reference to an alkaline saponification treatment as an example.

The alkaline saponification treatment is preferably carried out in a cycle including dipping of the film surface in an alkaline solution, neutralization with an acidic solution, washing with water and drying.

Examples of the alkaline solution include a potassium hydroxide solution and a sodium hydroxide solution. These alkaline solutions preferably have an alkali concentration of from 0.1 moles/L to 3.0 moles/L, and more preferably from 0.5 moles/L to 2.0 moles/L. The temperature of the alkaline solution is preferably in the range of from room temperature to 90° C., and more preferably from 40° C. to 70° C.

From the viewpoint of productivity, it is preferable that the alkaline solution is coated, and after the saponification treatment, the alkali is removed from the film surface by washing with water. From the viewpoint of wetting properties, alcohols such as IPA, n-butanol, methanol, and ethanol are preferable as a coating solvent. It is preferred to add water, propylene glycol, ethylene glycol, etc. as an auxiliary for alkaline dissolution.

Hard Coat Layer

For the sake of imparting a physical strength of the film, the antireflection film of the invention is provided a hard coat layer directly or indirectly on at least one side of the transparent support. In the invention, the antireflection film of the invention is constructed in such a manner that a low refractive index layer is provided directly or indirectly on the hard coat layer, and preferably, a medium refractive index layer and a high refractive index layer are provided between the hard coat layer and the low refractive index layer.

In the antireflection film of the invention, it is essential that the surface is made flat for the purposes of improving white blurring, image blurring, and a glaring phenomenon. Specifically, of the characteristics exhibiting the surface roughness, the centerline average roughness (Ra) is adjusted at not more than 0.10 μm. Ra is more preferably not more than 0.09 μm, and further preferably not more than 0.08 μm. In the antireflection film of the invention, the surface irregularities of the hard coat layer are dominant to the surface irregularities of the film. By making the centerline average roughness of the hard coat layer fall within the foregoing range, it is possible to make the centerline average roughness of the antireflection film fall within the foregoing range.

The antireflection film of the invention preferably has a transmitted image clarity of 60% or more. The transmitted image clarity is generally an index exhibiting the degree of blurring of an image reflected by transmitting a film. As this value becomes large, the image seen through the film becomes sharp and good. The transmitted image clarity is more preferably 70% or more, and further preferably 80% or more.

Here, the transmitted image clarity can be measured using an optical comb having a slit width of 0.5 mm by an image clarity meter (ICM-2D Model) manufactured by Suga Test Instruments Co., Ltd. according to JIS K7105.

With respect to the refractive index of the hard coat layer of the invention, the refractive index is preferably in the range of from 1.48 to 2.00, more preferably from 1.50 to 1.90, and further preferably from 1.50 to 1.80 in view of the optical design for the purpose of obtaining an antireflection film. In the invention, since at least one low refractive index layer is provided on the hard coat layer, when the refractive index of the hard coat layer is too low as compared with this range, the antireflection properties are lowered, whereas when it is too high, the tint of the reflected light tends to become strong.

With respect to the film thickness of the hard coat layer, the thickness of the hard coat layer is usually from about 0.5 μm to 50 μm, preferably from 1 μm to 20 μm, more preferably from 2 μm to 10 μm, and most preferably from 3 μm to 7 μm from the viewpoint of imparting sufficient durability and impact resistance to the film.

Also, with respect to the strength of the hard coat layer, the pencil hardness according to JIS K5400 is preferably H or more, more preferably 2H or more, and most preferably 3H or more.

Further, it is preferable that the abrasion wear of a specimen before and after the taper test according to JIS K5400 is as small as possible.

The hard coat layer is preferably formed by crosslinking reaction or polymerization reaction of an ionizing radiation-curable compound. For example, the hard coat layer can be formed by coating a coating solution containing an ionizing radiation-curable polyfunctional monomer or polyfunctional oligomer on a transparent support and subjecting the polyfunctional monomer or polyfunctional oligomer to crosslinking reaction or polymerization reaction.

As the functional group of the ionizing radiation-curable polyfunctional monomer or polyfunctional oligomer, photopolymerizable, electron beam-polymerizable or radiation-polymerizable functional groups are preferable. Of these photopolymerizable functional groups are especially preferable.

Examples of the photopolymerizable functional groups include unsaturated polymerizable functional groups such as a (meth)acryloyl group, a vinyl group, a styryl group, and an allyl group. Of these, a (meth)acryloyl group is preferable.

Specific examples of photopolymerizable functional group-containing photopolymerizable polyfunctional monomers include:

(meth)acrylic diesters of an alkylene glycol, such as neopentyl glycol acrylate, 1,6-hexanediol (meth)acrylate, and propylene glycol di(meth)acrylate;

(meth)acrylic diesters of a polyoxyalkylene glycol, such as triethylene glycol di(meth)acrylate, dipropylene glycol di(meth)acrylate, polyethylene glycol di(meth)acrylate, and polypropylene glycol di(meth)acrylate;

(meth)acrylic diesters of a polyhydric alcohol, such as pentaerythritol di(meth)acrylate; and

(meth)acrylic diesters of an ethylene oxide or propylene oxide adduct, such as 2,2-bis{4-(acryloxy.diethoxy)phenyl}propane and 2,2-bis{4-(acryloxy.polypropoxy)phenyl}propane.

Further, epoxy (meth)acrylates, urethane (meth)acrylates, and polyester (meth)acrylates are also preferably used as the photopolymerizable polyfunctional monomer.

Of these, esters of a polyhydric alcohol and (meth)acrylic acid are preferable; and polyfunctional monomers having three or more (meth)acryloyl groups in one molecule are more preferable. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)penta-erythritol hexa(meth)acrylate, tripentaerythritol triacrylate, and tripentaerythritol hexatriacrylate. In this specification, the terms “(meth)acrylate”, “(meth)acrylic acid” and “(meth)acryloyl” mean “acrylate or methacrylate”, “acrylic acid or methacrylic acid” and “acryloyl or methacryloyl”, respectively.

Two or more kinds of polyfunctional monomers may be used jointly.

The polymerization of such an ethylenically unsaturated group-containing monomer can be carried out upon irradiation with ionizing radiations or by heating in the presence of a photo-radical polymerization initiator or a heat radical polymerization initiator.

Examples of the photo-radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxydimethyl p-isopropylphenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone, and 4-t-butyldichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether, and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butylperoxycarbonyl)benzophenone.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic esters, and cyclic active ester compounds.

Examples of the onium salts include aromatic diazonium salts, aromatic iodonium salts, and aromatic sulfonium salts.

Examples of the borates include ion complexes with a cationic pigment.

As examples of the active halogens, s-triazine and oxathiazole compounds are known, including 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine, and 2-trihalogmethyl-5-(p-methoxyphenyl)-1,3,4-oxadiazole.

Examples of the inorganic complexes include bis-(η⁵-2,4-cyclopentadien-1-yl)-bis(2,6-difluoro-3-(1H-pyrrol-1-yl)-phenyl)titanium.

Examples of the coumarins include 3-ketocoumarin.

These initiators may be used singly or in admixture.

Various examples are also described in Saishin UV Koka Gijutsu (Latest UV Curing Technologies), page 159 (1991), Technical Information Institute Co., Ltd. and are useful in the invention.

Examples of commercially available photo-radical polymerization initiators include KAYACURE Series, manufactured by Nippon Kayaku Co., Ltd. (for example, DETX-S, BP-100, BDMK, CTX, BMS, 2-EAQ, ABQ, CPTX, EPD, ITX, QTX, BTC, and MCA), IRGACURE Series, manufactured by Ciba Specialty Chemicals (for example, 651, 184, 819, 500, 907, 369, 1173, 2959, 4265, and 4263), and ESACURE Series, manufactured by Sartomer Company Inc. (for example, KIP100F, KB1, EB3, BP, X33, KT046, KT37, KIP150, and TZT).

The amount of the photopolymerization initiator to be used is preferably in the range of from 0.1 to 15 parts by weight, and more preferably from 1 to 10 parts by weight based on 100 parts by weight of the polyfunctional monomer.

In addition to the photopolymerization initiator, a photosensitizer may be used. Specific examples of the photosensitizer include n-butylamine, triethylamine, tri-n-butylphosphine, Michler's ketone, and thioxanthone. Examples of commercially available photosensitizers include KAYACURE Series, manufactured by Nippon Kayaku Co., Ltd. (for example, DMBI and EPA).

The photopolymerization reaction is preferably carried out upon irradiation with ultraviolet rays after coating and drying of the hard coat layer.

As the heat radical initiator, organic or inorganic peroxides, organic azo or diazo compounds, and the like can be used.

Specifically, examples of the organic peroxides include benzoyl peroxide, halogen benzoyl peroxides, lauroyl peroxide, acetyl peroxide, dibutyl peroxide, cumene hydroperoxide, and butyl hydroperoxide; examples of the inorganic peroxides include hydrogen peroxide, ammonium persulfate, and potassium persulfate; examples of the azo compounds include 2,2′-azobis(isobutyronitrile), 2,2′-azobis(propionitrile), and 1,1′-azobis(cyclohexanecarbonitrile); and examples of the diazo compounds include diazoaminobenzene and p-nitrobenzenediazonium.

As the polymer containing a polyether as the principal chain, ring-opening polymers of a polyfunctional epoxy compound are preferable. The ring-opening polymerization of the polyfunctional epoxy compound can be carried out upon irradiation with ionizing radiations or by heating in the presence of a photo acid generator or a thermal acid generator.

Accordingly, the hard coat layer can be formed by preparing a coating solution containing a polyfunctional epoxy compound, a photo acid generator or a thermal acid generator, a light-transmitting fine particle and an inorganic filler and coating the coating solution on a transparent support, followed-by curing by polymerization reaction by ionizing radiations or heat.

A crosslinking structure may be introduced into the binder polymer by using a crosslinking functional group-containing monomer in place of or in addition to the monomer containing two or more ethylenically unsaturated groups, thereby introducing the crosslinking functional group into the polymer and reacting the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group, and an active methylene group. Vinylsulfonic acid, acid anhydrides, cyanoacrylate derivatives, melamine, etherified methylol, esters, urethanes, and metal alkoxides such as tetramethoxysilane can also be utilized as the monomer for introducing a crosslinking structure. Functional groups which exhibit crosslinking properties as a result of decomposition reaction, such as a block isocyanate group, may be used, too. That is, in the invention, the crosslinking functional group may be one which does not exhibit reactivity immediately but exhibits reactivity as a result of decomposition.

The binder polymer containing such a crosslinking functional group can form a crosslinking structure after coating and heating.

The crosslinked or polymerized binder of the hard coat layer has a structure in which the principal chain of a polymer is crosslinked or polymerized. Examples of the principal chain of a polymer include polyolefins (saturated hydrocarbons), polyethers, polyureas, polyurethanes, polyesters, polyamines, polyamides, and melamine resins. Of these, a polyolefin principal chain, a polyether principal chain, and a polyurea principal chain are preferable; a polyolefin principal chain and a polyether principal chain are more preferable; and a polyolefin principal chain is the most preferable.

The polyolefin principal chain is comprised of a saturated hydrocarbon. For example, the polyolefin principal chain is obtained by addition polymerization reaction of an unsaturated polymerizable group. The polyether principal chain is one in which repeating units are bonded via an ether bond (—O—). For example, the polyether principal chain is obtained by ring opening reaction of an epoxy group. The polyurea principal chain is one in which repeating units are bonded via a urea bond (—NH—CO—NH—). For example, the polyurea principal chain is obtained by polycondensation reaction between an isocyanate group and an amino group. The polyurethane principal chain is one in which repeating units are bonded via a urethane bond (—NH—CO—O—). For example, the polyurethane principal chain is obtained by polycondensation reaction between an isocyanate group and a hydroxyl group (including an N-methylol group). The polyester principal chain is one in which repeating units are bonded via an ester bond (—CO—O—). For example, the polyester principal chain is obtained by polycondensation reaction between a carboxyl group (including an acid halide group) and a hydroxyl group (including an N-methylol group). The polyamine principal chain is one in which repeating units are bonded via an imino bond (—NH—). For example, the polyamine principal chain is obtained by ring opening reaction of an ethyleneimine group. The polyamide principal chain is one in which repeating units are bonded via an amide bond (—NH—CO—). For example, the polyamide principal chain is obtained by reaction between an isocyanate group and a carboxyl group (including an acid halide group). For example, the melamine resin principal chain is obtained by polycondensation reaction between a triazine group (for example, melamine) and an aldehyde (for example, formaldehyde). Incidentally, in the melamine resin, the principal chain itself has a crosslinking or polymerization structure.

For the purpose of controlling the refractive index of the hard coat layer, a high refractive index monomer or an inorganic fine particle or both can be added to the binder of the hard coat layer. The inorganic fine particle has not only an effect for controlling the refractive index but also an effect of suppressing cure shrinkage by crosslinking reaction. In the invention, one including a polymer formed by polymerization of the foregoing polyfunctional monomer and/or high refractive index monomer after forming the hard coat layer and inorganic fine particle dispersed therein is called a binder.

Examples of the high refractive index monomer include bis(4-methacryloylthiophenyl) sulfide, vinylnaphthalene, biphenyl sulfide, and 4-methacryloxyplhenyl-4′-methoxyphenyl thioether.

Examples of the inorganic fine particle include an oxide of at least one metal selected from silicon, zirconium, titanium, aluminum, indium, zinc, tin and antimony, BaSO₄, CaCO₃, talc, and kaolin, and the particle size thereof is not more than 100 run, and preferably not more than 50 nm. By finely dividing the inorganic fine particle to not more than 100 nm, it is possible to form a hard coat layer whose transparency is not hindered.

For the purpose of making the hard coat layer have a high refractive index, ultra-fine particles of an oxide of at least one metal selected from Al, Zr, Zn, Ti, In and Sn are preferable. Specific examples thereof include ZrO₂, TiO₂, Al₂O₃, In₂O₃, ZnO, SnO₂, Sb₂O₃, and ITO. Of these, ZrO₂ is especially preferable for use.

The addition amount of the high refractive index monomer or inorganic fine particle is preferably from 10 to 90% by weight, and more preferably from 20 to 80% by weight of the total weight of the binder. Two or more kinds of inorganic fine particles may be used within the hard coat layer.

For the purpose of improving the viewing angle characteristics by scattering, the haze value of the hard coat layer is preferably 10% or more, more preferably from 20% to 80%, further preferably from 30% to 70%, and most preferably from 35% to 60%.

The antireflection film of the invention is a film in which the surface irregularities are very small or not substantially present, and the surface haze is not substantially present. In the case of imparting a haze, it is preferred to provide the haze as an internal haze. Accordingly, the hard coat layer has an internal haze, namely, it has internal scattering properties. As a result, the haze value of the antireflection film is preferably 10% or more, more preferably from 20% to 80%, further preferably from 30% to 70%, and most preferably from 35% to 60%.

In order to impart a viewing angle enlargement performance, in addition to the adjustment of the foregoing haze value, it is important to adjust the intensity distribution of scattered light (scattered light profile) in the hard coat layer as measured by a goniophotometer. For example, in the case of a liquid crystal display, as the outgoing light from backlight is diffused by the antireflection film placed on the surface of a polarizing plate in the viewing side, the viewing angle characteristics become good. However, when the outgoing light is excessively diffused, there are encountered such problems that the back scattering becomes large, whereby the front luminance is reduced and that the scattering is too large, thereby deteriorating the image clarity. Accordingly, it is necessary to control the intensity distribution of scattered light of the hard coat layer within a certain range. For the sake of achieving desired viewing angle characteristics, the intensity of scattered light having an outgoing angle of 30°, as especially correlated to an effect for improving the viewing angle, with respect to an intensity of light having an outgoing angle of 0° of a scattered light profile is preferably from 0.01% to 0.2%, more preferably from 0.02% to 0.15%, and most preferably from 0.02% to 0.1%.

The scattered light profile can be measured with respect to an antireflection film provided with a hard coat layer using a goniophotometer, GP-5 Model, manufactured by Murakami Color Research Laboratory.

As a method of imparting internal scattering properties to the hard coat layer or a method of imparting a desired scattered light profile, it is preferred to contain a light-transmitting particle having a different refractive index from the binder. A difference of the refractive index between the binder and the light-transmitting particle is preferably from 0.02 to 0.20. Within the foregoing range of a difference of the refractive index, not only an adequate light diffusing effect is revealed, but also there is no fear that the whole of the film is whitened due to an excessive light diffusing effect. Incidentally, the foregoing difference of the refractive index is more preferably from 0.03 to 0.15, and most preferably from 0.04 to 0.13.

The combination of the binder and the light-transmitting particle can be properly selected for the purpose of adjusting the foregoing difference of the refractive index.

The particle size of the light-transmitting particle is preferably from 0.5 μm to 5 μm. When the particle size falls within the foregoing range, the light diffusing effect is adequate, the back scattering is small so that the utilization efficiency of light is sufficient, and the surface irregularities are small so that white blurring or a glaring phenomenon does not substantially take place. Incidentally, the particle size of the foregoing light-transmitting particle is more preferably from 0.7 μm to 4.5 μm, and most preferably from 1.0 μm to 4.0 μm.

In the case of containing the light-transmitting particle in the hard coat layer, it is necessary to adjust the thickness of the hard coat layer such that the surface irregularities are not formed due to the foregoing particle. In general, by making the thickness large such that a projection of the particle is not protruded from the hard coat surface, it is possible to adjust the surface roughness Ra (centerline average roughness) at not more than 0.10 μm.

The light-transmitted particle may be an organic particle or an inorganic particle. The less the scattering of the particle size, the smaller the scattering of the scattering characteristics, and thus, it becomes easy to design the haze value. As the light-transmitting fine particle, plastic beads are suitable; and ones having high transparency and having the foregoing numeral value of a difference of the refractive index from the binder are especially preferable.

Examples of the organic particle include polymethyl methacrylate beads (refractive index: 1.49), acryl-styrene copolymer beads (refractive index: 1.54), melamine beads (refractive index: 1.57), polycarbonate beads (refractive index: 1.57), styrene beads (refractive index: 1.60), crosslinked polystyrene beads (refractive index: 1.61), polyvinyl chloride beads (refractive index: 1.60), and benzoguanamine-melamine formaldehyde beads (refractive index: 1.68).

Examples of the inorganic particle include silica beads (refractive index: 1.44) and alumina beads (refractive index: 1.63).

The particle size of the light-transmitting particle may be properly selected within the foregoing range of from 0.5 to 5 μm; two or more kinds of light-transmitting particles may be used; and the content of the light-transmitting particle is from 5 to 30 parts by weight based on 100 parts by weight of the binder.

In the case of the foregoing light-transmitting particle, since the light-transmitting particle is liable to sediment in the binder, an inorganic filler such as silica may be added for the purpose of preventing the sedimentation. Incidentally, as the addition amount of the inorganic filler is increased, it becomes more effective to prevent the sedimentation of the light-transmitting particle. However, the transparency of the coating film is adversely affected. Accordingly, it is preferable that an inorganic filler having a particle size of not more than 0.5 μm is contained in an amount less than about 0.1% by weight in the binder in such a manner that the transparency of the coating is not hindered.

Surfactant for Hard Coat Layer

In particular, for the purposes of improving planar failures such as coating unevenness, drying unevenness, and point defect and securing planar uniformity, in the hard coat layer of the invention, it is preferable that either one or both of a fluorine based surfactant and a silicone based surfactant are contained in the coating composition for forming a light diffusion layer. Especially, since a fluorine based surfactant reveals an effect for improving planar failures of the antireflection film of the invention, such as coating unevenness, drying unevenness, and point defect, in a smaller addition amount, it is preferably used.

It is aimed to enhance the productivity by bringing high-speed coating adaptability while enhancing the planar uniformity.

As a preferred example of the fluorine based surfactant, there is enumerated a fluoro aliphatic group-containing copolymer (sometimes abbreviated as “fluorine based polymer”). As the fluorine based polymer, copolymers of an acrylic resin or a methacrylic resin which is characterized by containing a repeating unit corresponding to the following monomer (i) or a repeating unit corresponding to the following monomer (ii) and a vinyl based monomer which is copolymerizable therewith are useful.
(i) Fluoro aliphatic group-containing monomer represented by the following general formula (a):

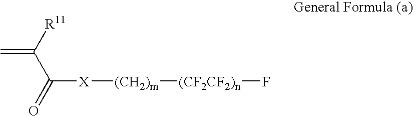

In the general formula (a), R¹¹ represents a hydrogen atom or a methyl group; X represents an oxygen atom, a sulfur atom, or —N(R¹²)—; m represents an integer of from 1 to 6; and n represents an integer of from 2 to 4. R¹² represents a hydrogen atom or an alkyl group having from 1 to 4 carbon atoms (for example, a methyl group, an ethyl group, a propyl group, and a butyl group), with a hydrogen atom and a methyl group being preferable. X is preferably an oxygen atom.
(ii) Monomer represented by the following general formula (b), which is copolymerizable with the foregoing (i):

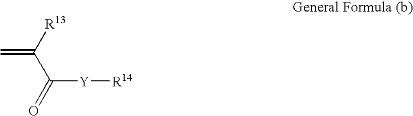

In the general formula (b), R¹³ represents a hydrogen atom or a methyl group; Y represents an oxygen atom, a sulfur atom, or —N(R¹⁵); and R¹⁵ represents a hydrogen atom or an alkyl group having from 1 to 4 carbon atoms (for example, a methyl group, an ethyl group, a propyl group, and a butyl group), with a hydrogen atom and a methyl group being preferable. X is preferably an oxygen atom, —N(H)—, or —N(CH₃)—.

R¹⁴ represents an optionally substituted linear, branched or cyclic alkyl group having from 4 to 20 carbon atoms. Examples of the substituent of the alkyl group represented by R¹⁴ include a hydroxyl group, an alkylcarbonyl group, an arylcarbonyl group, a carboxyl group, an alkyl ether group, an aryl ether group, a halogen atom (for example, a fluorine atom, a chlorine atom, and a bromine atom), a nitro group, a cyano group, and an amino group. But, it should not be construed that the invention is limited thereto. Examples of the linear, branched or cyclic alkyl group having from 4 to 20 carbon atoms include a butyl group, a heptyl group, a hexyl group, a heptyl group, an octyl group, a nonyl group, a decyl group, au undecyl group, a dodecyl group, a tridecyl group, a tetradecyl group, a pentadecyl group, an octadecyl group, and an eicosanyl group, each of which may be linear or branched; a monocyclic cycloalkyl group such as a cyclohexyl group and a cycloheptyl group; and polycyclic cycloalkyl group such as a bicycloheptyl group, a bicyclodecyl group, a tricycloundecyl group, a tetracyclododecyl group, an adamantly group, a norbornyl group, and a tetracyclodecyl group.

The amount of the fluoro aliphatic group-containing monomer represented by the general formula (a), which is used in the fluorine based polymer to be used in the invention, is in the range of 10% by mole or more, preferably from 15 to 70% by mole, and more preferably from 20 to 60% by mole based on each monomer of the fluorine based polymer.

The weight average molecular weight of the fluorine based polymer to be used in the invention is preferably from 3,000 to 100,000, and more preferably from 5,000 to 80,000.

Further, the addition amount of the fluorine based polymer to be used in the invention is in the range of from 0.001 to 5% by weight, preferably from 0.005 to 3% by weight, and more preferably from 0.01 to 1 % by weight based on the coating solution. When the addition amount of the fluorine based polymer is less than 0.001% by weight, the effect is not sufficient, whereas when it exceeds 5% by weight, drying of the coating film is not sufficiently carried out, or the performance (for example, reflectance and abrasion resistance) as the coating film is adversely affected.

Examples of a specific structure of the fluorine based polymer comprising the fluoro aliphatic group-containing monomer represented by the general formula (a) will be given below, but it should not be construed that the invention is limited thereto. Incidentally, the numerals in the formulae show a molar ratio of the respective monomer components. Mw represents a weight average molecular weight.

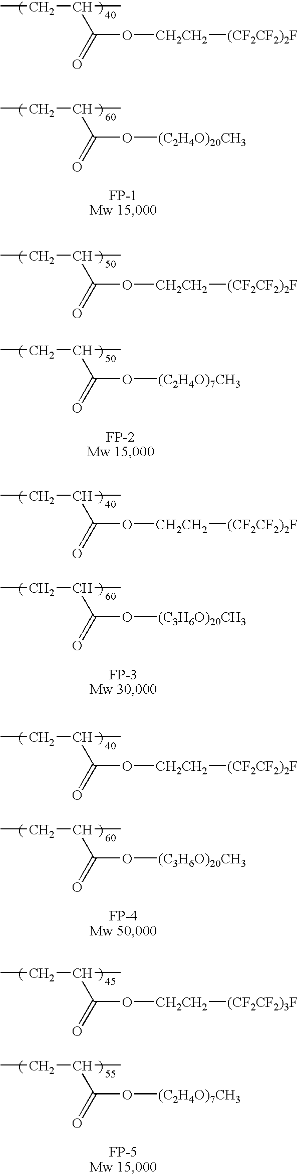

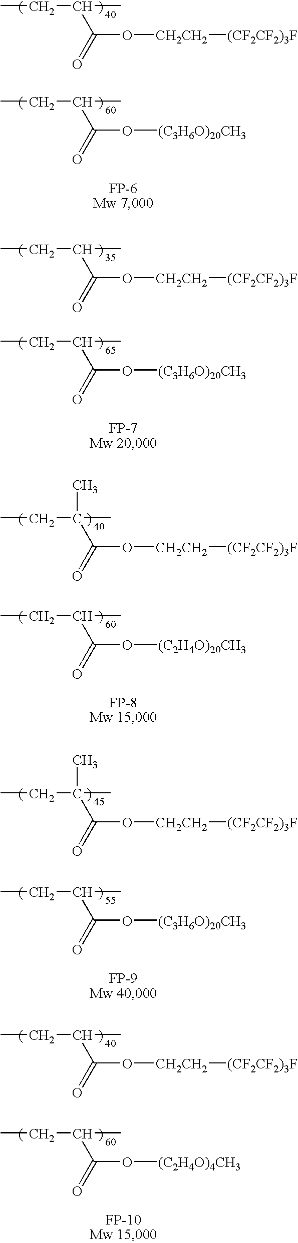

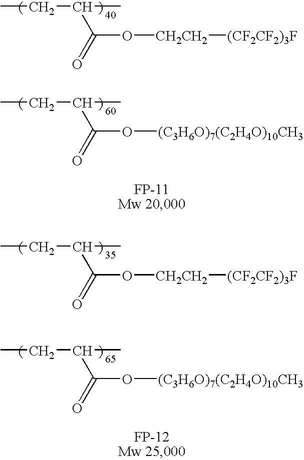

However, by using the foregoing fluorine based polymer, the F atom-containing functional group is segregated on the surface of the hard coat layer, whereby the surface energy of an anti-glare layer is lowered. As a result, there is caused a problem that when a low refractive index layer is provided as a topcoat on the foregoing hard coat layer, the antireflection performance becomes worse. It is estimated that this is caused by the matter that since wetting properties of the curable composition to be used for forming a low refractive index layer become worse, fine unevenness of the low refractive index layer which cannot be visually detected becomes worse. In order to solve such a problem, it has been found that it is effective to control the hard coat layer so as to have surface energy of preferably from 20 mN·m⁻¹ to 50 mN·m⁻¹, and more preferably from 30 m·Nm¹ to 40 m·Nm¹ by adjusting the structure and addition amount of the fluorine based polymer. In order to realize the foregoing surface energy, it is required that F/C which is a ratio of a peak derived from the fluorine atom to a peak derived from the carbon atom as measured by the X-ray photoelectron spectroscopy is from 0.1 to 1.5.

Alternatively, when an upper layer is coated, by selecting a fluorine based polymer which can be extracted by a solvent for forming the upper layer, the fluorine based polymer is not unevenly distributed on the surface of a lower layer (i.e., the interface), thereby bring adhesiveness between the upper layer and the lower layer. Thus, by keeping planar uniformity even in high-speed coating and preventing a lowering of the surface free energy capable of providing an antireflection film having strong abrasion resistance, it is possible to achieve the object by controlling the surface energy of the hard coat layer before coating a low refractive index layer within the foregoing range. Examples of such a raw material include copolymers of an acrylic resin or a methacrylic resin which is characterized by containing a repeating unit corresponding to a fluoro aliphatic group-containing monomer represented by the following general formula (c) and a vinyl based monomer which is copolymerizable therewith.
(iii) Fluoro aliphatic group-containing monomer represented by the following general formula (c):

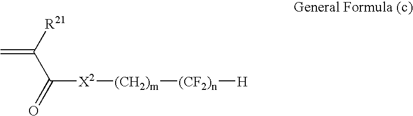

In the general formula (c), R²¹ represents a hydrogen atom, a halogen atom, or a methyl group; and preferably a hydrogen atom or a methyl group. X² represents an oxygen atom, a sulfur atom, or —N(R²²)—; preferably an oxygen atom or —N(²²)—; and more preferably an oxygen atom. m represents an integer of from 1 to 6 (preferably from 1 to 3, and more preferably 1); and n represents an integer of from 1 to 18 (preferably from 4 to 12, and more preferably from 6 to 8). R²² represents a hydrogen atom or an optionally substituted alkyl group having from 1 to 8 carbon atoms; preferably a hydrogen atom or an alkyl group having from 1 to 4 carbon atoms; and more preferably a hydrogen atom or a methyl group. X² is preferably an oxygen atom.

Also, two or more kinds of the fluoro aliphatic group-containing monomer represented by the general formula (c) may be contained as constitutional components in the fluorine based polymer.
(iv) Monomer represented by the following general formula (d), which is copolymerizable with the foregoing (iii):

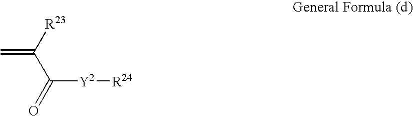

In the general formula (d), R²³ represents a hydrogen atom, a halogen atom, or a methyl group; and preferably a hydrogen atom or a methyl group. Y² represents an oxygen atom, a sulfur atom, or —N(R²⁵)—; preferably an oxygen atom or —N(R²⁵)—; and more preferably an oxygen atom. R²⁵ represents a hydrogen atom or an alkyl group having from 1 to 8 carbon atoms; preferably a hydrogen atom or an alkyl group having from 1 to 4 carbon atoms; and more preferably a hydrogen atom or a methyl group.

R²⁴ represents an optionally substituted linear, branched or cyclic alkyl group having from 1 to 20 carbon atoms, a poly(alkyleneoxy) group-containing alkyl group, or an optionally substituted aromatic group (for example, a phenyl group and a naphthyl group); preferably a linear, branched or cyclic alkyl group having from 1 to 12 carbon atoms or an aromatic group having from 6 to 18 carbon atoms in total; and more preferably a linear, branched or cyclic alkyl group having from 1 to 8 carbon atoms.

Examples of a specific structure of the fluorine based polymer containing a repeating unit corresponding to the fluoro aliphatic group-containing monomer represented by the general formula (c) will be given below, but it should not be construed that the invention is limited thereto. Incidentally, the numerals in the formula show a molar ratio of the respective monomer components. Mw represents a weight average molecular weight.

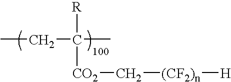

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

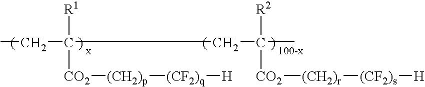

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

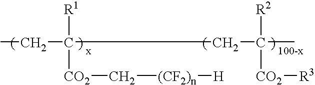

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉ (n) | 7000 |
| FP-150 | 95 | H | 4 | H | C₆H₁₃ (n) | 5000 |
| FP-151 | 90 | CH₃ | 4 | H | CH₂CH(C₂H₅)C₄H₉ (n) | 15000 |
| FP-152 | 70 | H | 6 | CH₃ | C₂H₅ | 18000 |
| FP-153 | 90 | H | 6 | CH₃ | 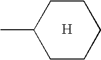 | 12000 |
| FP-154 | 80 | H | 6 | H | C₄H₉ (sec) | 9000 |
| FP-155 | 90 | H | 6 | H | C₁₂H₂₅ (n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉ (n) | 5000 |
| FP-160 | 50 | H | 8 | H | C₄H₉ (n) | 16000 |
| FP-161 | 80 | H | 8 | CH₃ | C₄H₉ (iso) | 13000 |
| FP-162 | 80 | H | 8 | CH₃ | C₄H₉ (t) | 9000 |
| FP-163 | 60 | H | 8 | H | 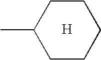 | 7000 |
| FP-164 | 80 | H | 8 | H | CH₂CH(C₂H₅)C₄H₉ (n) | 8000 |
| FP-165 | 90 | H | 8 | H | C₁₂H₂₅ (n) | 6000 |
| FP-166 | 80 | CH₃ | 8 | CH₃ | C₄H₉ (sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

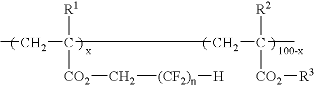

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₈H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂— | 12000 |
| | | | | | C₄H₉ (n) | |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O₇—H | 8000 |
| FP-184 | 95 | H | 8 | H | —(C₃H₆O)₂₀—H | 15000 |
| FP-185 | 90 | F | 8 | H | —(C₂H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

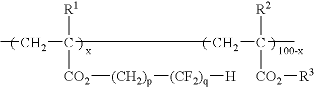

| | x | R¹ | p | q | R² | R³ | Mw |
|---|---|---|---|---|---|---|---|
| FP-193 | 80 | H | 2 | 4 | H | C₄H₉ (n) | 18000 |
| FP-194 | 90 | H | 2 | 4 | H | —(CH₂CH₂O)₉—CH₃ | 16000 |
| FP-195 | 90 | CH₂ | 2 | 4 | F | C₆H₁₃ (n) | 24000 |
| FP-196 | 80 | CH₃ | 1 | 6 | F | C₄H₉ (n) | 18000 |
| FP-197 | 95 | H | 2 | 6 | H | —(C₃H₆O)₇—H | 21000 |
| FP-198 | 90 | CH₃ | 3 | 6 | H | —CH₂CH₂OH | 9000 |
| FP-199 | 75 | H | 1 | 8 | F | CH₃ | 12000 |
| FP-200 | 80 | H | 2 | 8 | H | CH₂CH(C₂H₅) | 34000 |
| | | | | | | C₄H₉ (n) | |
| FP-201 | 90 | CH₃ | 2 | 8 | H | —(C₃H₆O)₇—H | 11000 |
| FP-202 | 80 | H | 3 | 8 | CH₃ | CH₃ | 18000 |
| FP-203 | 90 | H | 1 | 10 | F | C₄H₉ (n) | 27000 |
| FP-204 | 95 | H | 2 | 10 | H | —(CH₂CH₂O)₉—CH₃ | 12000 |
| FP-205 | 85 | CH₃ | 2 | 10 | CH₃ | C₄H₉ (n) | 20000 |
| FP-206 | 80 | H | 1 | 12 | H | C₆H₁₃ (n) | 8000 |
| FP-207 | 90 | H | 1 | 12 | H | —(C₃H₆O)₁₃—H | 15000 |
| FP-208 | 60 | CH₃ | 3 | 12 | CH₃ | C₂H₅ | 12000 |
| FP-209 | 60 | H | 1 | 16 | H | CH₂CH(C₂H₅) | 20000 |
| | | | | | | C₄H₉ (n) | |
| FP-210 | 80 | CH₃ | 1 | 16 | H | —(CH₂CH₂O)₂ | 17000 |
| | | | | | | —C₄H₉ (n) | |
| FP-211 | 90 | H | 1 | 18 | H | —CH₂CH₂OH | 34000 |
| FP-212 | 60 | H | 3 | 18 | CH₃ | CH₃ | 19000 |

Also, by preventing a lowering of the surface energy at the time of providing a low refractive index layer as a top coat on the hard coat layer, it is possible to prevent deterioration of the antireflection performance. By using a fluorine based polymer at the time of coating a hard coat layer to decrease the surface tension of a coating solution, thereby enhancing the planar uniformity, keeping high productivity by high-speed coating and employing a surface treatment measure such as a corona treatment, a UV treatment, a heat treatment, a saponification treatment, and a solvent treatment, and especially preferably a corona treatment after coating the hard coat layer, thereby preventing a lowering of the surface free energy, it is possible to achieve the object by controlling the surface energy of the hard coat layer before coating a low refractive index layer within the foregoing range.

Also, a thixotropic agent may be added in the coating composition for forming the hard coat layer of the invention. Examples of the thixotropic agent include silica and mica each having a particle size of not more than 0.1 μm. The content of such an additive is suitably from about 1 to 10 parts by weight based on 100 parts by weight of the ultraviolet ray-curing resin.

In the case where the hard coat layer comes into contact with the transparent support, it is preferable that a solvent of a coating solution for forming the hard coat layer is constructed of at least one kind of a solvent which dissolves the transparent support (for example, a triacetyl cellulose support) therein and at least one kind of a solvent which does not dissolve the transparent support therein for the purpose of designing to cope with both control of irregularities of the surface of the hard coat layer (making the irregularities small or flattening the surface) and adhesion between the transparent support and the hard coat layer. More preferably, at least one kind of the solvent which does not dissolve the transparent support therein has a higher boiling point than at least one kind of die solvent which dissolves the transparent support therein. Further preferably, a difference of the boiling point between a solvent having the highest boiling point among solvents which do not dissolve the transparent support therein and a solvent having the highest boiling point among solvents which dissolve the transparent support therein is 30° C. or more, and most preferably 50° C. or more.

Examples of solvents which dissolve the transparent support (preferably triacetyl cellulose) include:

ethers having from 3 to 12 carbon atoms (specific examples thereof include dibutyl ether, dimethoxymethane, dimethoxyethane, diethoxyethane, propylene oxide, 1,4-dioxane, 1,3-dioxolan, 1,3,5-trioxane, tetrahydrofuran, anisole, and phenetole);

ketones having from 3 to 12 carbon atoms (specific examples thereof include acetone, methyl ethyl ketone, diethyl ketone, dipropyl ketone, diisobutyl ketone, cyclopentanone, cyclohexanone, and methylcyclohexanone;

esters having from 3 to 12 carbon atoms (specific examples thereof include ethyl formate, propyl formate, n-pentyl formate, methyl acetate, ethyl acetate, methyl propionate, ethyl propionate, n-pentyl acetate, and γ-butyrolactone); and

organic solvents having two or more kinds of functional groups (specific examples thereof include methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, and ethyl acetoacetate).

These solvents can be used singly or in admixture of two or more kinds thereof. As the solvent which dissolves the transparent support therein, ketone based solvents are preferable.

Examples of solvents which do not dissolve the transparent support (preferably triacetyl cellulose) therein include methanol, ethanol, 1-propanol, 2-propanol, 1-butanol, 2-butanol, tert-butanol, 1-pentanol, 2-methyl-2-butanol, cyclohexanol, isobutyl acetate, methyl isobutyl ketone, 2-octanone, 2-pentanone, 2-hexanone, 2-heptanone, 3-pentanone, 3-heptanone, and 4-heptanone.

These solvents can be used singly or in admixture of two or more kinds thereof.

The weight ratio (A/B) of the total amount (A) of the solvent which dissolves the transparent support therein to the total amount (B) of the solvent which does not dissolve the transparent support therein is preferably from 5/95 to 50/50, more preferably from 10/90 to 40/60, and further preferably from 15/85 to 30/70.

Low Refractive Index Layer

The antireflection film of the invention has a low refractive index layer in the outermost layer. The refractive index of the low refractive index layer is preferably from 1.20 to 1.46, more preferably from 1.25 to 1.41, and most preferably from 1.30 to 1.39. Further, it is preferable that the low refractive index layer is satisfied with the following expression (1) in view of realization of a low refractive index.
(m₁λ/4)×0.7<n₁d₁<(m₁λ/4)×1.3 Expression (1)

In the foregoing expression (1), m₁ represents a positive odd number; n₁ represents a refractive index of the low refractive index layer; and d₁ represents a thickness (nm) of the low refractive index layer. Also, λ represents a wavelength and is a value in the range of from 500 to 550 nm. Incidentally, what the foregoing expression (1) is satisfied means that m₁ (a positive odd number, and usually 1) which is satisfied with the expression (1) within the foregoing wavelength range is present.

In the low refractive index layer, a binder is used for the purpose of dispersing and fixing the hollow silica particle of the invention. As the binder, the binder described previously for the hard coat layer can be used, but it is preferred to use a fluorine-containing polymer in which the refractive index of the binder itself is low, or a fluorine-containing sol-gel raw material. As the fluorine-containing polymer or the fluorine-containing sol-gel, raw materials which are crosslinked by heat or ionizing radiations, have a coefficient of dynamic friction of the surface of the low refractive index layer to be formed of from 0.03 to 0.15, and have a contact angle against water of from 90 to 120° are preferable.

Fluorine-Containing Polymer

Examples of the fluorine-containing polymer to be used in the low refractive index layer include not only hydrolysates or dehydration condensates of perfluoroalkyl group-containing silane compounds (for example, (heptadecafluoro-1,1,2,2-tetrahydrodecyl)triethoxysilane) but also fluorine-containing copolymers comprising a fluorine-containing monomer unit and a constitutional unit for imparting crosslinking reactivity as constitutional components.

Specific examples of the fluorine-containing monomer unit include fluoroolefins (for example, fluoroethylene, vinylidene fluoride, tetrafluoroethylene, hexafluoropropylene, and perfluoro-2,2-dimethyl-1,3-dioxole), partially or fully fluorinated alkyl ester derivatives of (meth)acrylic acid (for example, Viscoat 6FM (manufactured by Osaka Organic Chemical Industry Ltd.) and M-2020 (manufactured by Daikin Industries, Ltd.), and fully or partially fluorinated vinyl ethers. Of these, perfluoroolefins are preferable; and hexafluoropropylene is especially preferable from the viewpoints of refractive index, solubility, transparency, easy availability, etc.

As the constitutional unit for imparting crosslinking reactivity, units represented by the following (A), (B) and (C) are mainly enumerated.
(A) A constitutional unit obtained by polymerization of a monomer having previously a self-crosslinking functional group in the molecule thereof, such as glycidyl (meth)acrylate and glycidyl vinyl ether.
(B) A constitutional unit obtained by polymerization of a monomer having a carboxyl group, a hydroxyl group, an amino group, a sulfo group, etc. (for example, (meth)acrylic acid, methylol (meth)acrylate, hydroxyalkyl (meth)acrylates, allyl acrylate, hydroxyethyl vinyl ether, hydroxybutyl vinyl ether, maleic acid, and crotonic acid).
(C) A constitutional unit obtained by reacting a compound containing a group which is reactive with the foregoing functional group (A) or (B) and other crosslinking functional group in the molecule thereof with the foregoing constitutional unit (A) or (B) (for example, a constitutional unit which can be synthesized by a measure for exerting acrylic chloride to a hydroxyl group or other measures).

In particular, in the foregoing constitutional unit (C) of the invention, it is preferable that the crosslinking functional group is a photopolymerizable group. Examples of the photopolymerizable group as referred to herein include a (meth)acryloyl group, an alkenyl group, a cinnamoyl group, a cinnamylidene acetyl group, a benzalacetophenone group, a styrylpyridine group, an α-phenylmaleimide group, a phenylazide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, and an azadioxabicyclo group. These groups may be contained singly or in admixture of two or more kinds thereof. Of these, a (meth)acryloyl group and a cinnamoyl group are preferable, and a (meth)acryloyl group is especially preferable.

As a specific method for preparing the photopolymerizable group-containing copolymer, the following methods can be enumerated, but it should not be construed that the invention is limited thereto.
(1) A method of esterification by reacting (meth)acrylic chloride with a crosslinking functional group-containing copolymer containing a hydroxyl group.
(2) A method of urethanation by reacting an isocyanate group-containing (meth)acrylic ester with a crosslinking functional group-containing copolymer containing a hydroxyl group.
(3) A method of esterification by reacting (meth)acrylic acid with a crosslinking functional group-containing copolymer containing an epoxy group.
(4) A method of esterification by reacting an epoxy group-containing (meth)acrylic ester with a crosslinking functional group-containing copolymer containing a carboxyl group.

Incidentally, the amount of the foregoing photopolymerizable group to be introduced can be arbitrarily adjusted. It is preferred to leave a certain amount of a carboxyl group, a hydroxyl group, etc. from the standpoints of coating film planar stability, a lowering of planar failure at the time of co-presence of an inorganic fine particle, enhancement of film strength, etc.

Also, besides the foregoing fluorine-containing monomer unit and constitutional unit for imparting crosslinking reactivity, a fluorine atom-free monomer can be properly copolymerized from the viewpoints of solubility in the solvent, transparency of the film, etc. The monomer unit which can be used jointly is not particularly limited, and examples thereof include olefins (for example, ethylene, propylene, isoprene, vinyl chloride, and vinylidene chloride), acrylic esters (for example, methyl acrylate, ethyl acrylate, and 2-ethylhexyl acrylate), methacrylic esters (for example, methyl methacrylate, ethyl methacrylate, butyl methacrylate, and ethylene glycol dimetlacrylate), styrene derivatives (for example, styrene, divinylbenzene, vinyltoluene, and α-methylstyrene), vinyl ethers (for example, methyl vinyl ether, ethyl vinyl ether, and cyclohexyl vinyl ether), vinyl esters (for example, vinyl acetate, vinyl propionate, and vinyl cinnamate), acrylamides (for example, N-tert-butyl-acrylamide and N-cyclohexylacrylamide), methacrylamides, and acrylonitrile derivatives.

In the invention, random copolymers of a perfluoroolefin and a vinyl ether or a vinyl ester are especially useful as the fluorine-containing polymer. In particular, it is especially preferable that the fluorine-containing polymer has an independently crosslinkable group (for example, radical reactive groups such as a (meth)acryloyl group and ring opening polymerizable groups such as an epoxy group and an oxetanyl group). The crosslinkable group-containing polymeric unit preferably accounts for from 5 to 70% by mole, and especially preferably from 30 to 60% by mole of the whole of polymeric units of the polymer. As the preferred polymer, there are enumerated ones described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462.

Also, it is preferable that a polysiloxane structure is introduced in the fluorine-containing polymer of the invention for the purpose of imparting stain resistance. A method of introducing a polysiloxane structure is not limited, but for example, a method of introducing a polysiloxane block copolymer component using a silicone macroazo initiator as described in JP-A-11-189621, JP-A-11-228631, and JP-A-2000-313709 and a method of introducing a polysiloxane graft copolymer component using a silicone macromer as described in JP-A-2-251555 and JP-A-2-308806 are preferable. The content of the polysiloxane component is preferably from 0.5 to 10% by weight, and especially preferably from 1 to 5% by weight in the polymer.

Besides the foregoing methods, a measure for adding a reactive group-containing polysiloxane (for example, KF-100T, X-22-169AS, KF-102, X-22-37011E, X-22-164B, X-22-5002, X-22-173B, X-22-174D, X-22-167B and X-22-161AS (all of which are a trade name, manufactured by Shin-Etsu Chemical Co., Ltd.); AK-5, AK-30 and AK-32 (all of which are a trade name, manufactured by Toagosei Co., Ltd.); and SILAPLANE FM0275 and SILAPLANE FM0721 (all of which are manufactured by Chisso Corporation) is also preferable for the purpose of imparting stain resistance. Such a polysiloxane is preferably added in an amount ranging from 0.5 to 10% by weight, and especially preferably from 1 to 5% by weight based on the whole of solids of the low refractive index layer.

A preferred molecular weight of the polymer which can be preferably used in the invention is 5,000 or more, preferably from 10,000 to 500,000, and most preferably 15,000 to 200,000 in terms of weight average molecular weight. By jointly using polymers having a different average molecular weight, the coating film planar properties and the abrasion resistance can be improved.

A hardener described in each of JP-A-10-25388 and JP-A-10-147739 may be properly used in combination with the foregoing polymer. It is also preferred to use a compound containing a fluorine-containing polyfunctional polymerizable unsaturated group described in JP-A-2000-17028 and JP-A-2002-145952 in combination. As a preferred example thereof, the polyfunctional monomers described previously for the hard coat layer can be enumerated.

Fluorine-Containing Silane Based Compound

In the low refractive index layer in which the hollow silica of the invention is used, a hydrolysate of an organosilane based compound having high compatibility with silica and/or a condensate thereof can be used as a binder. Specific examples of the binder include ones described in JP-A-2002-79616, JP-A-2002-265866, and JP-A-2002-317152. Also, in view of stain resistance, it is preferred to provide a stain-resistant layer as described in JP-A-2002-277604.

Hollow Silica Fine Particle

For the purpose of coping with both low refractive index and abrasion resistance, a hollow silica fine particle is contained in the low refractive index layer of the invention.

For the purpose of coping with both low refractive index and abrasion resistance, a hollow silica fine particle is contained in the low refractive index layer of the invention.

The refractive index of the hollow silica fine particle is preferably from 1.15 to 1.40, more preferably from 1.17 to 1.35, and most preferably from 1.17 to 1.30. The refractive index as referred to herein represents a refractive index of the whole of the particles but not a refractive index of only silica of the outer shell forming the hollow silica fine particle. At this time, when the radius of a void in the particle is defined as “a”, and the radius of the outer shell of the particle is defined as “b”, a porosity “x” is calculated according to the following expression (VIII):
x=(4πa³/3)/(4πb³/3)×100 Expression (VIII)

The porosity (x) is preferably from 10 to 60%, more preferably from 20 to 60%/o, and most preferably from 30 to 60%. When the hollow silica fine particle is made to have a lower refractive index and to have a larger porosity, the thickness of the outer shell becomes thin, and the strength of the particle becomes weak. Accordingly, particles having a low refractive index as less than 1.15 are not preferable from the viewpoint of the abrasion resistance.

The production method of the hollow silica fine particle is described in, for example, JP-A-2001-233611 and JP-A-2002-79616. In particular, particles having a void in the inside of the shell, in which the pores of the shell are clogged, are preferable. Incidentally, the refractive index of these hollow silica particles can be calculated according to a method described in JP-A-2002-79616.

The coating amount of the hollow silica fine particle is preferably from 1 mg/m² to 100 mg/m², more preferably from 5 mg/m² to 80 mg/m², and further preferably from 10 mg/m² to 60 mg/m². When the coating amount falls within the foregoing range, not only an effect for realizing a low refractive index and an effect for improving the abrasion resistance are revealed, but also fine irregularities are not generated on the surface of the low refractive index layer, and there is no fear of deterioration of the appearance such as real black and integrated reflectance.

The average particle size of the hollow silica fine particle is from 5 nm to 200 nm, preferably from 20 nm to 150 nm, more preferably from 30 nm to 80 nm, and further preferably from 40 nm to 65 nm.

When the particle size of the hollow silica fine particle falls within the foregoing range, the rate of voids is proper; the refractive index is lowered; and the surface of the low refractive index layer is free from deterioration of the appearance such as real black and integrated reflectance based on the fine irregularities.

The silica in the outer shell portion of the hollow silica fine particle may be crystalline or amorphous. Also, though the size distribution of the hollow silica fine particle is preferably of a monodispersed particle, it may be of a polydispersed particle, or may be even of a coagulated particle so far as a prescribed particle size is met. Although the shape is most preferably spherical, there is no problem even when it is an infinite form.

Also, two or more kinds of particles having a different average particle size can be used in combination as the hollow silica.

Here, the average particle size of the hollow silica fine particle can be determined from an electron microscopic photograph.

In the invention, a specific surface area of the hollow silica is preferably from 20 to 300 m²/g, more preferably from 30 to 120 m²/g, and most preferably from 40 to 90 m²/g. The surface area can be determined using nitrogen by the BET method.

In the invention, for the purpose of enhancing the abrasion resistance, other inorganic filler can be contained together with the hollow silica fine particle.

Since the inorganic filler is contained in the low refractive index layer, it is desired to have a low refractive index. Examples thereof include magnesium fluoride and silica. In particular, a void-free silica fine particle is preferable in view of refractive index, dispersion stability and costs. Tie particle size of the void-free silica fine particle is preferably from 30 nm to 150 nm, more preferably from 35 nm to 80 mu, and most preferably from 40 nm to 60 nm.

Also, it is preferable that at least one kind of silica fine particles having an average particle size of less than 25% of the thickness of the low refractive index (hereinafter referred to as “silica fine particle of a small particle size”) is used jointly with the silica fine particle having the foregoing particle size (hereinafter referred to as “silica fine particle of a large particle size”).

The silica fine particle of a small particle size can exist in gaps among silica fine particles of a large particle size and therefore, can contribute as a holding agent of the silica fine particle of a large particle size.

The average particle size of the silica fine particle of a small particle size is preferably from 1 nm to 20 nm, more preferably from 5 nm to 15 nu, and especially preferably from 10 nm to 15 nm. The use of such a silica fine particle is preferable in view of the costs of raw materials and a holding agent effect.

In order to design to stabilize the dispersion in a dispersion liquid or coating solution or to enhance compatibility with and bonding properties to the binder component, the silica fine particle may be subjected to a physical surface treatment such as a plasma discharge treatment and a corona discharge treatment, or a chemical surface treatment with a surfactant, a coupling agent, etc. The use of a coupling agent is especially preferable. As the coupling agent, alkoxymetal compounds (for example, titanium coupling agents and silane coupling agents) are preferable for use. Of these, silane coupling agents are especially preferable. Organosilane compounds represented by the following general formulae (2) and (3) are preferable, and the treatment with a silane coupling agent having an acryloyl group or a methacryloyl group is especially effective.

The foregoing coupling agent may be used for previously subjecting the inorganic filler of the low refractive index layer to a surface treatment before the preparation of a coating solution for the subject layer as a surface treating agent. However, it is preferable that the coupling agent is further contained in the low refractive index layer as an additive at the time of preparation of a coating solution for the subject layer.

In order to reduce a load of the surface treatment, it is preferable that the silica fine particle is previously dispersed in a medium before the surface treatment. As specific compounds of the surface treating agent and catalyst which can be preferably used in the invention, organosilane compounds and catalysts described in, for example, WO 2004/017105 can be enumerated.

In the invention, in view of abrasion resistance, it is preferable that at least one of a hydrolysate of an organosilane compound and a partial condensate thereof, i.e., a so-called sol component (hereinafter referred to as “sol component”) is contained in at least one layer of the hard coat layer and the low refractive index layer. More preferably, at least one of a hydrolysate of an organosilane compound and a partial condensate thereof is contained in both the hard coat layer and the low refractive index layer.

The organosilane compound to be used can be represented by the following general formula (2).
(R¹⁰)ₘ—Si(X)₄₋ₘ General Formula (2)

In the foregoing general formula (2), R¹⁰ represents a substituted or unsubstituted alkyl group or a substituted or unsubstituted aryl group.

X represents a hydrolysable group, and preferred examples thereof include an alkoxy group (preferably an alkoxy group having from 1 to 5 carbon atoms, for example, a methoxy group and an ethoxy group), a halogen (for Cl, Br, and I), and R²COO (wherein R² preferably represents a hydrogen atom or an alkyl group having from 1 to 5 carbon atoms, for example, CH₃COO and C₂H₅COO). X preferably represents an alkoxy group, especially preferably a methoxy group or an ethoxy group.

m represents an integer of from 1 to 3. When plural R¹⁰'s or X's are present, the plural R¹⁰'s or X's may be the same or different m is preferably 1 or 2, and especially preferably 1.

The substituent contained in R¹⁰ is not particularly limited, and examples thereof include a halogen (for example, fluorine, chlorine, and bromine), a hydroxyl group, a mercapto group, a carboxyl group, an epoxy group, an alkyl group (for example, methyl, ethyl, isopropyl, propyl, and tert-butyl), an aryl group (for example, phenyl and naphtyl), an aromatic heterocyclic group (for example, furyl, pyrazolyl, and pyridyl), an alkoxy group (for example, methoxy, ethoxy, isopropoxy, and hexyloxy), an aryloxy group (for example, phenoxy), an alkylthio group (for example, methylthio and ethylthio), an arylthio group (for example, phenylthio), an alkenyl group (for example, vinyl and 1-propenyl), an acyloxy group (for example, acetoxy, acryloyloxy, and methacryloyloxy), an alkoxycarbonyl group (for example, methoxycarbonyl and ethoxycarbonyl), an aryloxycarbonyl group (for example, phenoxycarbonyl), a carbamoyl group (for example, carbamoyl, N-methylcarbamoyl, N,N-dimethylcarbamoyl, and N-methyl-N-octylcarbamoyl), and an acylamino group (for example, acetylamino, benzoylamino, acrylamino, and methacrylamino). These substituents may further be substituted.

In the case where plural R¹⁰'s are present, it is preferable that at least one R¹⁰ represents a substituted alkyl group or a substituted aryl group.

Of the organosilane compounds represented by the general formula (2), organosilane compounds having a vinyl polymerizable substitutent, which are represented by the following general formula (3), are preferable.

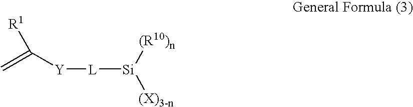

In the general formula (3), R¹ represents a hydrogen atom, an alkyl group (for example, a methyl group and an ethyl group), an alkoxy group (for example, a methoxy group and an ethoxy group), an alkoxycarbonyl group (for example, a methoxycarbonyl group and an ethoxycarbonyl group), a cyano group, or a halogen atom (for example, a fluorine atom and a chlorine atom). Of these, a hydrogen atom, a methyl group, a methoxy group, a methoxycarbonyl group, a cyano group, a fluorine atom, and a chlorine atom are preferable; a hydrogen atom, a methyl group, a methoxycarbonyl group, a fluorine atom, and a chlorine atom are more preferable; and a hydrogen atom and a methyl group are especially preferable.

Y represents a single bond, an ester group, an amide group, an ether group, or a urea group. Of these, a single bond, an ester group, and an amide group are preferable; a single bond and an ester group are more preferable; and an ester group is especially preferable.

L represents a divalent connecting group. Specific examples thereof include a substituted or unsubstituted alkylene group, a substituted or unsubstituted arylene group, a substituted or unsubstituted alkylene group having a connecting group (for example, an ether, an ester, and an amide) therein, and a substituted or unsubstituted arylene group having a connecting group therein. Of these, a substituted or unsubstituted alkylene group, a substituted or unsubstituted arylene group, and an alkylene group having a connecting group therein are preferable; an unsubstituted alkylene group, an unsubstituted arylene group, and an alkylene group having a connection group comprising an ether or an ester therein are more preferable; and an unsubstituted alkylene group and an alkylene group having a connecting group comprising an ether or an ester therein are especially preferable. Examples of the substituent include a halogen, a hydroxyl group, a mercapto group, a carboxyl group, an epoxy group, an alkyl group, and an aryl group. These substituents may further be substituted.

n is 0 or 1. When plural X's are present, the plural X's may be the same or different. n is preferably 0.

R¹⁰ is synonymous with that in the general formula (2) and is preferably a substituted or unsubstituted alkyl group or an unsubstituted aryl group, and more preferably an unsubstituted alkyl group or an unsubstituted aryl group.

X is synonymous with that in the general formula (2) and is preferably a halogen, a hydroxyl group, or an unsubstituted alkoxy group, more preferably a chlorine atom, a hydroxyl group, or an unsubstituted alkoxy group having from 1 to 6 carbon atoms, further preferably a hydroxyl group or an alkoxy group having from 1 to 3 carbon atoms, and especially preferably a methoxy group.

As the organosilane compound, two or more kinds of the compounds represented by the general formulae (2) or (3) may be used jointly. Specific examples of the compounds represented by the general formulae (2) and (3) will be given below, but it should not be construed that the invention is limited thereto.

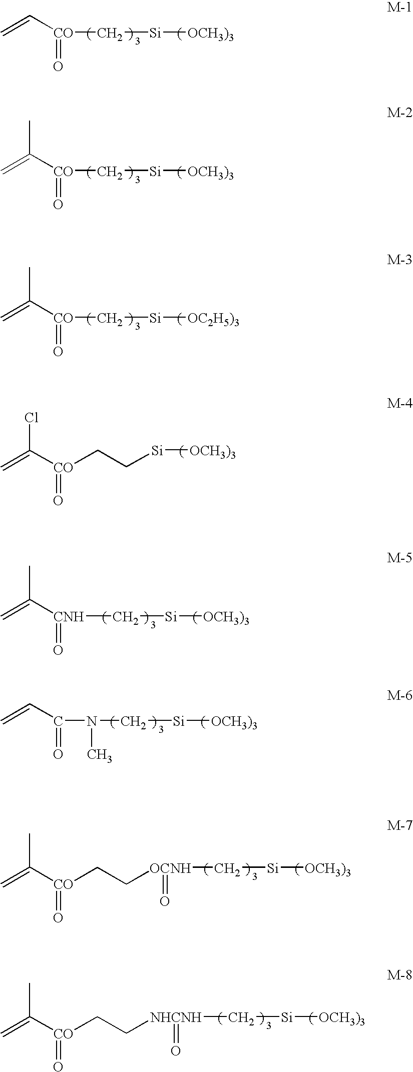

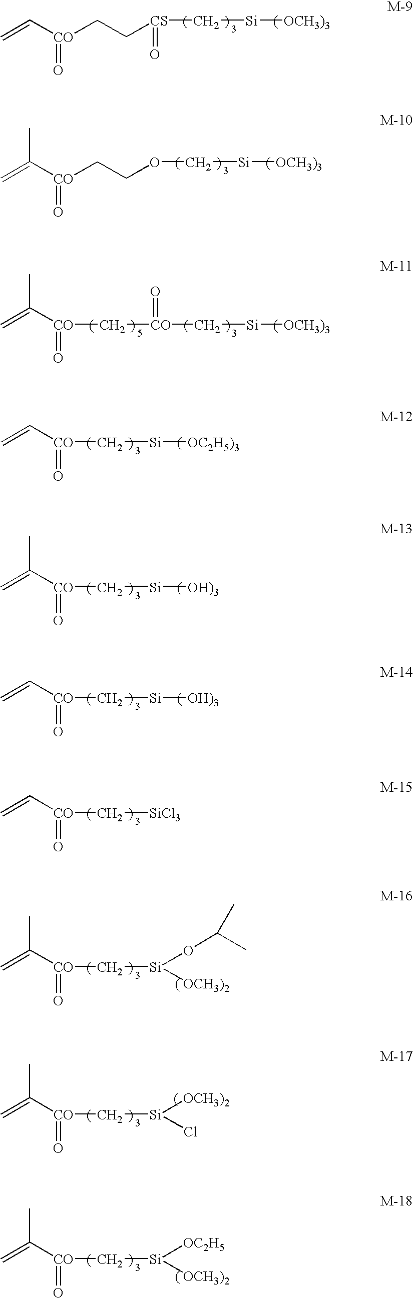

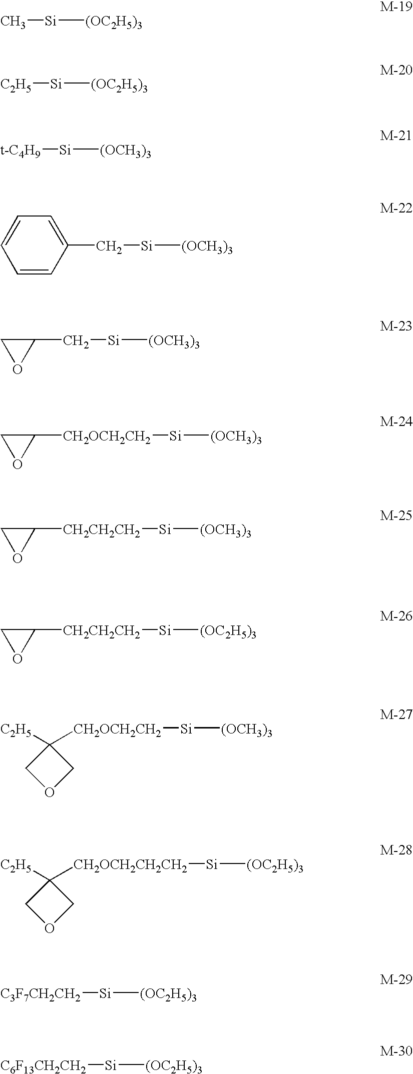

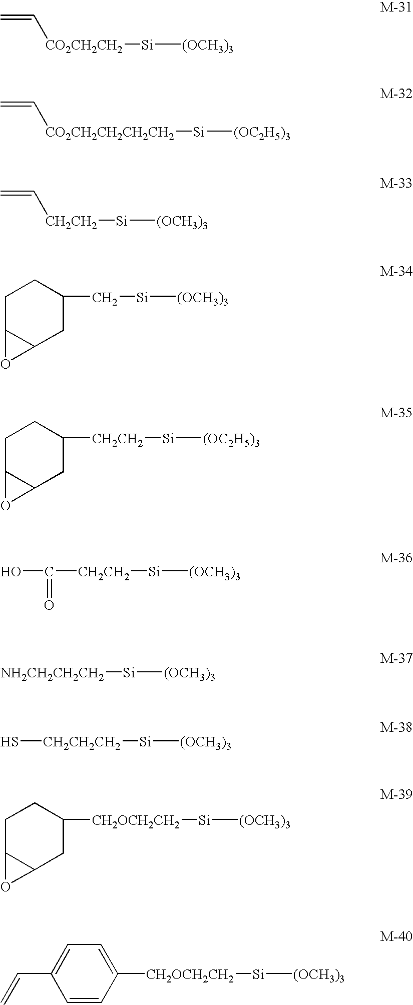

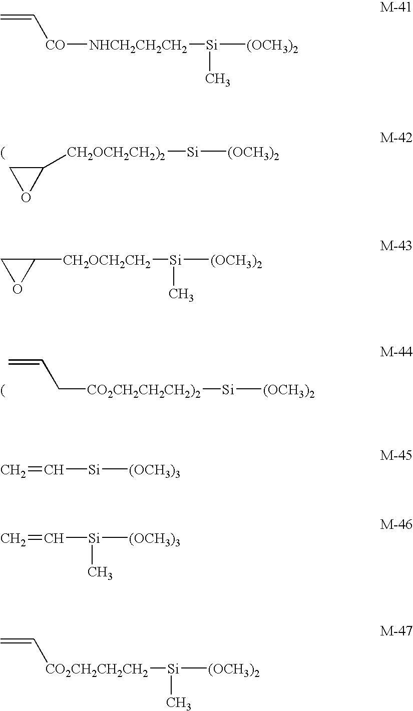

The hydrolysis and condensation reaction of an organosilane can be carried out in the presence or absence of a solvent but is preferably carried out using an organic solvent for the purpose of uniformly mixing the components. As the organic solvent, alcohols, aromatic hydrocarbons, ethers, ketones, esters, and the like are suitable.

A solvent which dissolves both the organosilane and a catalyst therein is preferable. Also, use of the organic solvent as a coating solution or part of a coating solution is preferable in view of steps. In the case of mixing with other raw material such as a fluorine-containing polymer, one which does not impair the solubility or dispersibility is preferable.

Of these, examples of the alcohols include monohydric or dihydric alcohols. Of these alcohols, saturated aliphatic alcohols having from 1 to 8 carbon atoms are preferable as the monohydric alcohol. Specific examples of these alcohols include methanol, ethanol, n-propyl alcohol, isopropyl alcohol, n-butyl alcohol, sec-butyl alcohol, tert-butyl alcohol, ethylene glycol, diethylene glycol, triethylene glycol, ethylene glycol monobutyl ether, and acetic acid ethylene glycol monoethyl ether.

Also, specific examples of the aromatic hydrocarbons include benzene, toluene, and xylene; specific examples of the ethers include tetrahydrofuran and dioxane; specific examples of the ketones include acetone, methyl ethyl ketone, methyl isobutyl ketone, and diisobutyl ketone; and specific examples of the esters include ethyl acetate, propyl acetate, butyl acetate, and propylene carbonate.

These organic solvents can be used singly or in admixture of two or more kinds thereof.

The concentration of the solids in the reaction is not particularly limited but is usually in the range of from 1% to 90%, and preferably from 20% to 70%.

The hydrolysis and condensation reaction of an organosilane is preferably carried out in the presence of a catalyst. Examples of the catalyst include inorganic acids such as hydrochloric acid, sulfuric acid, and nitric acid; organic acids such as oxalic acid, acetic acid, formic acid, methanesulfonic acid, and toluenesulfonic acid; inorganic salts such as sodium hydroxide, potassium hydroxide, and ammonia; organic bases such as triethylamine and pyridine; metal alkoxides such as triisopropoxylaluminum and tetrabutoxyzirconium; and metal chelate compounds. Of these, acid catalysts (for example, inorganic acids and organic acids) and metal chelate compounds are preferable from the standpoints of production stability of a sol liquid and storage stability of a sol liquid. With respect to the acid catalyst, the inorganic acid is preferably hydrochloric acid or sulfuric acid; and the organic acid is preferably an organic acid having an acid dissociation constant (pKa value (at 25° C.) in water of not more than 4.5, more preferably an organic acid having an acid dissociation constant in hydrochloric acid, sulfuric acid or water of not more than 3.0, further preferably an organic acid having an acid dissociation constant in hydrochloric acid, sulfuric acid or water of not more than 2.5, and even further preferably an organic acid having an acid dissociation constant in water of not more than 2.5. Of these, methanesulfonic acid, oxalic acid, phthalic acid, and malonic acid are preferable; and oxalic acid is especially preferable.

The hydrolysis and condensation reaction is usually carried out by adding water in an amount of from 0.3 to 2 moles, and preferably from 0. 5 to 1 mole per mole of the hydrolysable group of the organosilane in the presence or absence, and preferably in the presence of the foregoing solvent at from 25 to 100° C. with stirring.

In the case where the hydrolysable group is an alkoxide, and the catalyst is an organic acid, since the carboxyl group or sulfo group of the organic acid supplies a proton, the addition amount of water can be reduced. In this case, the addition amount of water is from 0 to 2 moles, preferably from 0 to 1.5 moles, more preferably from 0 to 1 mole, and especially preferably from 0 to 0.5 moles per mole of the alkoxide group of the organosilane. In the case of using an alcohol as the solvent, the case where water is not substantially added is also suitable.

In the case where the catalyst is an inorganic acid, the use amount of the catalyst is from 0.01 to 10% by mole, and preferably from 0.1 to 5% by mole with respect to the hydrolysable group. In the case where the catalyst is an organic acid, though the optimum use amount of the catalyst varies depending upon the addition amount of water, in the case where water is added, the use amount of the catalyst is from 0.01 to 10% by mole, and preferably from 0.1 to 5% by mole with respect to the hydrolysable group; and in the case where water is not substantially added, the use amount of the catalyst is from 1 to 500% by mole, preferably from 10 to 200% by mole, more preferably from 20 to 200% by mole, further preferably from 50 to 150% by mole, and especially preferably from 50 to 120% by mole with respect to the hydrolysable group.

Although the reaction is carried out with stirring at from 25 to 100° C., it is preferable that the reaction is properly adjusted depending upon the reactivity of the organosilane.

As the metal chelate compound, ones comprising an alcohol represented by the general formula: R³OH (wherein R³ represents an alkyl group having from 1 to 10 carbon atoms) and a compound represented by the general formula: R⁴COCH₂COR⁵ (wherein R⁴ represents an alkyl group having from 1 to 10 carbon atoms, and R⁵ represents an alkyl group having from 1 to 10 carbon atoms or an alkoxy group having from 1 to 10 carbon atoms) as ligands and comprising a metal selected from Zr, Ti and Al as a central metal can be suitably used without particular limitations. Within this scope, two or more kinds of metal chelate compounds may be used jointly. The metal chelate compound to be used in the invention is preferably one selected from the group of compounds represented by the general formulae: Zr(OR³)ₚ₁(R⁴COCHCOR⁵)ₚ₂, Ti(OR³)_{q1}(R⁴COCHCOR⁵)_{q2}, and Al(OR³)ᵣ₁(R⁴COCHCOR⁵)ᵣ₂ and has an action to promote a condensation reaction of the foregoing hydrolysate and/or partial condensate of an organosilane compound.

In the metal chelate compounds, R³ and R⁴ may be the same or different and each represents an alkyl group having from 1 to 10 carbon atoms (for example, an ethyl group, an n-propyl group, an isopropyl group, an n-butyl group, a sec-butyl group, a t-butyl group, an n-pentyl group, and a phenyl group). Also, R⁵ represents an alkyl group having from 1 to 10 carbon atoms the same as that described previously or an alkoxy group having from 1 to 10 carbon atoms (for example, a methoxy group, an ethoxy group, an n-propoxy group, an isopropoxy group, an n-butoxy group, a sec-butoxy group, and a t-butoxy group). Also, in the metal chelate compounds, p1, p2, q1, q2, r1, and r2 each represents an integer as determined such that (p1+p2) is equal to 4, (q1+q2) is equal to 4, and (r1+r2) is equal to 3, respectively.

Specific examples of these metal chelate compounds include zirconium chelate compounds such as tri-n-butoxyethyl acetoacetate zirconium, di-n-butoxybis(ethyl acetoacetate) zirconium, n-butoxytris(ethyl acetoacetate) zirconium, tetrakis(n-propyl acetoacetate) zirconium, tetrakis(acetyl acetoacetate) zirconium, and tetrakis(ethyl aetoacetate) zirconium; titanium chelate compounds such as diisopropoxybis(ethyl acetoacetate) titanium, diisopropoxybis(acetyl acetate) titanium, and diusopropoxybis(acetylacetone) titanium; and aluminum chelate compounds such as diisopropoxyethyl acetoacetate aluminum, diisopropoxyacetylacetonatoaluminum, isopropoxybis(ethyl acetoacetate) aluminum, isopropoxybis(acetylacetonato)aluniinum, tris(ethyl acetoacetate) aluminum, tris(acetylacetonato)aluminum, and monoacetylacetonatobis(ethyl acetoacetate) aluminum.

Of these metal chelate compounds, tri-n-butoxyethyl acetoacetate zirconium, diisopropoxybis(acetylacetonato)titanium, dipropoxyethyl acetoactate aluminum, and tris(ethyl acetoacetate) aluminum are preferable. These metal chelate compounds can be used singly or in admixture of two or more kinds thereof Also, a partial hydrolyzate of such a metal chelate compound can be used.

The metal chelate compound of the invention is preferably used in a proportion of from 0.01 to 50% by weight, more preferably from 0.1 to 50% by weight, and further preferably from 0.5 to 10% by weight based on the organosilane from the viewpoints of the rate of condensation reaction and the film strength when formed into a coating film.

Though the suitable content of the organosilane sol varies depending upon the layer to which the organosilane is added, the addition amount of the organosilane sol to the low refractive index layer is preferably from 0.1 to 50% by weight, more preferably from 0.5 to 20% by weight, and especially preferably from 1 to 10% by weight based on the whole of solids of the low refractive index layer. The addition amount of the organosilane sol to other layer than the low refractive index layer is preferably from 0.001 to 50% by weight, more preferably from 0.01 to 20% by weight, further preferably from 0.05 to 10%by weight, and especially preferably from 0.1 to 5% by weight based on the whole of solids of the layer to which the organosilane sol is added.

In the low refractive index layer, the use amount of the organosilane sol is preferably from 5 to 100% by weight, more preferably from 5 to 40% by weight, further preferably from 8 to 35% by weight, and especially preferably from 10 to 30% by weight based on the fluorine-containing polymer from the viewpoints of the effect for using the sol, the refractive index of the layer, and the shape and surface state of the layer to be formed.

With respect to the composition of a solvent of the coating solution to be used for forming the low refractive index layer according to the invention, the solvent may be used singly or in admixture. When the solvent is a mixed solvent, the proportion of a solvent having a boiling point of not higher than 100° C. is preferably from 50 to 100%, more preferably from 80 to 100%, further preferably from 90 to 100%, and even further preferably 100%. When the proportion of the solvent having a boiling point of not higher than 100° C. falls within the foregoing range, the drying speed is fast, the coated surface state is good, and the thickness of the coating film is uniform. Accordingly, optical characteristics such as reflectance become good.

Examples of the solvent having a boiling point of not higher than 100° C. include hydrocarbons such as hexane (boiling point: 68.7° C.; the term “° C.” will be hereinafter omitted), heptane (98.4), cyclohexane (80.7), and benzene (80.1); halogenated hydrocarbons such as dichloromethane (39.8), chloroform (61.2), carbon tetrachloride (76.8), 1,2-dichloroethane (83.5), and trichloroethylene (87.2); ethers such as diethyl ether (34.6), diisopropyl ether (68.5), dipropyl ether (90.5), and tetrahydrofuran (66); esters such as ethyl formate (54.2), methyl acetate (57.8), ethyl acetate (77.1), and isopropyl acetate (89); ketones such as acetone (56.1) and 2-butanone (=methyl ethyl ketone, 79.6); alcohols such as methanol (64.5), ethanol (78.3), 2-propanol (82.4), and 1-propanol (97.2); cyano compounds such as acetonitrile (81.6) and propionitrile (97.4); and carbon disulfide (46.2). Of these, ketones and esters are preferable; and ketones are especially preferable. Of the ketones, 2-butanone is especially preferable.

Examples of solvents having a boiling point of 100° C. or higher include octane (125.7), toluene (110.6), xylene (138), tetrachloroethylene (121.2), chlorobenzene (131.7), dioxane (101.3), dibutyl ether (142.4), isobutyl acetate (118), cyclohexanone (155.7), 2-methyl-4-pentanone (=MIBK, 115.9), 1-butanol (117.7), N,N-dimethylformamide (153), N,N-dimethylacetamide (166), and dimethyl sulfoxide (189). Of these, cyclohexanone and 2-methyl-4-pentanone are preferable.

By diluting the components of the low refractive index layer with a solvent having the foregoing composition, a coating solution for low refractive index layer is prepared. Though the concentration of the coating solution is properly adjusted while taking into consideration the viscosity of the coating solution and the specific gravity of the layer raw material, it is preferably from 0.1 to 20% by weight, and more preferably from 1 to 10% by weight.

High Refractive Index Layer

In the antireflection film of the invention, by providing a high refractive index layer and a medium refractive index layer on the hard coat layer, the antireflection properties can be enhanced. The refractive index of the high refractive index layer and the medium refractive index layer of the invention is preferably from 1.55 to 2.40. In this specification, the high refractive index layer and the medium refractive index layer will be hereinafter sometimes named generically as “high refractive index layer”. Incidentally, in the invention the terms “high”, “medium” and “low” of the high refractive index layer, the medium refractive index layer and the low refractive index layer express a relative size relationship of the refractive index among the layers. Also, with respect to the relationship with the transparent support, it is preferable that the refractive index is satisfactory with relationships of (transparent layer)>(low refractive index layer) and (high refractive index layer)>(transparent support).

It is preferable that the high refractive index layer of the invention contains an inorganic fine particle containing, as the major component, titanium dioxide and containing at least one element selected from cobalt, aluminum and zirconium. The major component as referred to herein means a component whose content (% by weight) is the highest among the components constituting the particles.

In the invention, the inorganic fine particle containing titanium dioxide as the major component preferably has a refractive index of from 1.90 to 2.80, more preferably from 2.10 to 2.80, and most preferably from 2.20 to 2.80.

The primary particle of the inorganic fine particle containing titanium dioxide as the major component preferably has a weight average size of from 1 to 200 nm, more preferably from 1 to 150 nm, further preferably from 1 to 100 nm, and especially preferably from 1 to 80 nm.

The particle size of the inorganic fine particle can be measured by the light scattering method or electron microscopic photography. The inorganic fine particle preferably has a specific surface area of from 10 to 400 m²/g, more preferably from 20 to 200 m²/g, and most preferably from 30 to 150 m²/g.

With respect to the crystal structure of the inorganic fine particle containing titanium dioxide as the major component, a rutile, rutile/anatase mixed crystal, anatase, or amorphous structure, and especially a rutile structure constitutes the major component. The major component as referred to herein means a component whose content (% by weight) is the highest among the components constituting the particles.

By containing at least one element selected from Co (cobalt), Al (aluminum) and Zr (zirconium) in the inorganic fine particle containing titanium dioxide as the major component, it is possible to suppress the photocatalytic activity which titanium dioxide has and to improve the weather resistance of the high refractive index layer of the invention.

An especially preferred element is Co (cobalt). Also, it is preferred to use two or more kinds of elements jointly.

The content of Co (cobalt), Al (aluminum) or Zr (zirconium) is preferably from 0.05 to 30% by weight, more preferably from 0.1 to 10% by weight, further preferably from 0.2 to 7% by weight, especially preferably from 0.3 to 5% by weight, and most preferably from 0.5 to 3% by weight based on Ti (titanium).

Though Co (cobalt), Al (aluminum) or Zr (zirconium) can be made present in at least one of the inside and the surface of the inorganic fine particle containing titanium dioxide as the major component, Co (cobalt), Al (aluminum) or Zr (zirconium) is preferably made present in the inside of, and most preferably in both the inside and the surface of the inorganic fine particle containing titanium dioxide as the major component.

For making Co (cobalt), Al (aluminum) or Zr (zirconium) present in the inside of the inorganic fine particle containing titanium dioxide as the major component, there are various measures. Examples thereof include measures described in Ion Implantation (Vol. 18, No. 5, pp. 262-268, 1998; Yasushi Aoki), JP-A-11-263620, JP-T-11-512336, EP-A-0335773, and JP-A-5-330825.

In the step of the particle formation of the inorganic fine particle containing titanium dioxide as the major component, a method of introducing Co (cobalt), Al (aluminum) or Zr (zirconium) (described in, for example, JP-T-11-512336, EP-A-0335773, and JP-A-5-330815) is especially preferable.

It is also preferable that Co (cobalt), Al (aluminum) or Zr (zirconium) is present as an oxide.

The inorganic fine particle containing titanium dioxide as the major component can further contain other elements depending upon the purpose. Other elements may be contained as impurities. Examples of other elements include Sn, Sb, Cu, Fe, Mn, Pb, Cd, As, Cr, Hg, Zn, Mg, Si, P, and S.

The inorganic fine particle containing titanium dioxide as the major component to be used in the invention may be subjected to a surface treatment. The surface treatment is carried out using an inorganic compound or an organic compound. Examples of the inorganic compound to be used for the surface treatment include cobalt-containing inorganic compounds (for example, CoO₂, Co₂O₃, and Co₃O₄), aluminum-containing inorganic compounds (for example Al₂O₃ and Al(OH)₃), zirconium-containing inorganic compounds (for example, ZrO₂ and Zr(OH)₄), silicon-containing inorganic compounds (for example, SiO₂), and iron-containing inorganic compounds (for example, Fe₂O₃).

Of these, cobalt-containing inorganic compounds, aluminum-containing inorganic compounds, and zirconium-containing inorganic compounds are especially preferable; and cobalt-containing inorganic compounds, Al(OH)₃, and Zr(OH)₄ are the most preferable.

Examples of the organic compound to be used in the surface treatment include silane coupling agents and titanate coupling agents. Of these, silane coupling agents are the most preferable, and examples thereof include silane coupling agents represented by the general formula (2) or (3).

The content of the silane coupling agent is preferably from 1 to 90% by weight, more preferably from 2 to 80% by weight, and especially preferably from 5 to 50% by weight based on the whole of solids of the high refractive index layer.

Examples of the titanate coupling agent include metal alkoxides such as tetramethoxytitanium, tetraethoxytitanium, and tetraisopropoxytitanium; and PLENACT Series (for example, KR-TTS, KR-46B, KR-55, and KR-41B, manufactured by Ajinomoto Co., Inc.).

As other organic compounds to be used in the surface treatment, polyols, alkanolamines, and other anionic group-containing organic compounds are preferable; and organic compounds having a carboxyl group, a sulfonic group, or a phosphoric group are especially preferable.

Stearic acid, lauric acid, oleic acid, linolic acid, linoleic acid, etc. can be preferably used.

It is preferable that the organic compound to be used in the surface treatment further has a crosslinking or polymerizable functional group. Examples of the crosslinking or polymerizable functional group include ethylenically unsaturated groups capable of undergoing addition reaction or polymerization reaction by a radical species (for example, a (meth)acryl group, an allyl group, a styryl group, and a vinyloxy group), cationic polymerizable groups (for example, an epoxy group, an oxetanyl group, and a vinyloxy group), and polycondensation reactive groups (for example, hydrolysable silyl groups and an N-methylol group). Of these, groups having an ethylenically unsaturated group are preferable.

Two or more kinds of these surface treatments can be employed jointly. It is especially preferred to use an aluminum-containing inorganic compound and a zirconium-containing inorganic compound jointly.

The inorganic fine particle containing titanium dioxide as the major component according to the invention may have a core/shell structure by means of a surface treatment as described in JP-A-2001-166104.

The shape of the inorganic fine particle containing titanium dioxide as the major component, which is contained in the high refractive index layer, is preferably of a grain of rice, or is spherical, cubic, spindle-shaped or amorphous, and especially preferably amorphous or spindle-shaped.

Dispersant

In dispersing the inorganic fine particle containing titanium dioxide as the major component, which is used in the high refractive index layer of the invention, a dispersant can be used.

In dispersing the inorganic fine particle containing titanium dioxide as the major component according to the invention, it is especially preferred to use an anionic group-containing dispersant.

As the anionic group, acidic proton-containing groups such as a carboxyl group, a sulfonic group (and a sulfo group), a phosphoric group (and a phosphono group), and a sulfonamide group, and salts thereof are effective. Of these, a carboxyl group, a sulfonic group, a phosphoric group, and salts thereof are preferable; and a carboxyl group and a phosphoric group are especially preferable. With respect to the number of the anionic group to be contained in the dispersant per molecule, it may be sufficient that at least one anionic group is contained.

Plural anionic groups may be contained for the purpose of further improving the dispersibility of the inorganic fine particle. The number of the anionic group is preferably 2 or more, more preferably 5 or more, and especially preferably 10 or more in average. Also, plural kinds of anionic groups to be contained in the dispersant may be contained in one molecule.

It is preferable that the dispersant further contains a crosslinking or polymerizable functional group. Examples of the crosslinking or polymerizable functional group include ethylenically unsaturated groups capable of undergoing addition reaction or polymerization reaction by a radical species (for example, a (meth)acryl group, an allyl group, a styryl group, and a vinyloxy group), cationic polymerizable groups (for example, an epoxy group, an oxetanyl group, and a vinyloxy group), and polycondensation reactive groups (for example, hydrolysable silyl groups and an N-methylol group). Of these, groups having an ethylenically unsaturated group are preferable.

The dispersant to be used for dispersing the inorganic fine particle containing titanium dioxide as the major component, which is used in the high refractive index layer of the invention, is preferably a dispersant having an anionic group and a crosslinking or polymerizable functional group and having the crosslinking or polymerizable functional group in the side chain thereof.

The weight average molecular weight (Mw) of the dispersant having an anionic group and a crosslinking or polymerizable functional group and having the crosslinking or polymerizable functional group in the side chain thereof is not particularly limited but is preferably 1,000 or more. The weight average molecular weight (Mw) of the dispersant is more preferably from 2,000 to 1,000,000, further preferably from 5,000 to 200,000, and especially preferably from 10,000 to 100,000.

As tie anionic group, acidic proton-containing groups such as a carboxyl group, a sulfonic group (and a sulfo group), a phosphoric group (and a phosphono group), and a sulfonamide group, and salts thereof are effective. Of these, a carboxyl group, a sulfonic group, a phosphoric group, and salts thereof are preferable; and a carboxyl group and a phosphoric group are especially preferable. The number of the anionic group to be contained in the dispersant per molecule is preferably 2 or more, more preferably 5 or more, and especially preferably 10 or more in average. Also, plural kinds of anionic groups to be contained in the dispersant may be contained in one molecule.

The dispersant having an anionic group and a crosslinking or polymerizable functional group and having the crosslinking or polymerizable functional group in the side chain thereof has the foregoing anionic group in the side chain or terminal thereof. With respect to a method of introducing an anionic group in the side chain thereof, the synthesis can be carried out by utilizing polymeric reaction such as a method of polymerizing an anionic group-containing monomer (for example, (meth)acrylic acid, maleic acid, a partially esterified maleic acid, itaconic acid, crotonic acid, 2-carboxyethyl (meth)acrylate, 2-sulfoethyl (meth)acrylate, and phosphoric acid mono-2-(meth)acryloyloxyethyl ester) and a method of exerting an acid anhydride to a polymer containing a hydroxyl group, an amino group, etc.

In the dispersant having an anionic group in the side chain thereof, the composition of an anionic group-containing repeating unit is in the range of from 10⁻⁴ to 100% by mole, preferably from 1 to 50% by mole, and especially preferably from 5 to 20% by mole of the whole of repeating units.

On the other hand, with respect to a method of introducing an anionic group in the terminal thereof, the synthesis can be carried out by a measure of undergoing polymerization reaction in the presence of an anionic group-containing chain transfer agent (for example, thioglycolic acid), a measure of undergoing polymerization reaction using an anionic group-containing polymerization initiator (for example, V-501, manufacture by Wako Pure Chemical Industries, Ltd.), or the like.

An especially preferred dispersant is a dispersant having an anionic group in the side chain thereof.

Examples of the crosslinking or polymerizable functional group include ethylenically unsaturated groups capable of undergoing addition reaction or polymerization reaction by a radical species (for example, a (meth)acryl group, an allyl group, a styryl group, and a vinyloxy group), cationic polymerizable groups (for example, an epoxy group, an oxetanyl group, and a vinyloxy group), and polycondensation reactive groups (for example, hydrolysable silyl groups and an N-methylol group). Of these, groups having an ethylenically unsaturated group are preferable.

The number of the crosslinking or polymerizable functional group to be contained in the dispersant per molecule is preferably 2 or more, more preferably 5 or more, and especially preferably 10 or more in average. Also, plural kinds of crosslinking or polymerizable functional group to be contained in the dispersant may be contained in one molecule.

In a preferred dispersant to be used in the invention, examples of the repeating unit having an ethylenically unsaturated group in the side chain thereof include repeating units of a poly-1,2-butadiene or poly-1,2-isoprene structure or an ester or amide of (meth)acrylic acid, to which a specific residue (an R group in —COOR or —CONHR) is bonded. Examples of the foregoing specific residue (R group) include —(CH₂)ₙ—CR₁═CR₂R₃, —(CH₂O)ₙ—CH₂CR₁═CR₂R₃, —(CH₂CH₂O)ₙ—CH₂CR₁═CR₂R₃, —(CH₂)ₙ—NH—CO—O—CH₂CR₁═CR₂R₃, —(CH₂)ₙ—O—CO—CR₁═CR₂R₃, and —(CH₂CH₂O)₂—X (wherein R₁ to R₃ each represents a hydrogen atom, a halogen atom, or an alkyl group, an aryl group, an alkoxy group or an aryloxy group each having from 1 to 20 carbon atoms, and R₁ and R₂ or R₃ may be taken together to form a ring; n represents an integer of from 1 to 10; and X represents a dicyclopentadienyl residue). Specific examples of the ester residue include —CH₂CH═CH₂, —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₃, and —CH₂CH₂O—X (wherein X represents a dicyclopentadienyl residue). Specific examples of the amide residue include —CH₂CH═CH₂, —CH₂CH₂—Y (wherein Y represents a 1-cyclohexenyl residue), —CH₂CH₂—OCO—CH═CH₂, and —CH₂CH₂—OCO—C(CH₃)═CH₂.

In the foregoing ethylenically unsaturated group-containing dispersant, a free radical (a polymerization initiation radical or a growth radical in the polymerization step of a polymerizable compound) is added to an unsaturated bonding group thereof to cause addition polymerization between molecules directly or via a polymerization chain of the polymerizable compound, whereby crosslinking is formed between the molecules to undergo curing. Alternatively, an atom in the molecule (for example, a hydrogen atom on the carbon atom adjacent to the unsaturated bonding group) is withdrawn by a free radical to form polymer radicals, and the polymer radicals are bonded to each other, whereby crosslinking is formed between the molecules to undergo curing.

With respect to a method of introducing a crosslinking or polymerizable functional group in the side chain, the synthesis can be carried out by a method in which after copolymerization of a crosslinking or polymerizable functional group-containing monomer (for example, allyl (meth)acrylate, glycidyl (meth)acrylate, and a tri-alkoxysilylpropyl methacrylate), copolymerization of butadiene or isoprene, or copolymerization of a vinyl monomer containing a 3-chloropropionic ester site, dehydrochlorination is carried out, as described in JP-A-3-249653; introduction of a crosslinking or polymerizable functional group by polymeric reaction (for example, polymeric reaction of an epoxy group-containing vinyl monomer into a carboxyl group-containing polymer); or other methods.

Though the crosslinking or polymerizable group-containing unit may constitute all of the repeating units other than the anionic group-containing unit, it preferably accounts for from 5 to 50% by mole, and especially preferably from 5 to 30% by mole of the whole of the crosslinking or polymerizable repeating units.

The preferred dispersant of the invention may be a copolymer with a suitable monomer other than the crosslinking or polymerizable function group-containing or anionic group-containing monomer. Though the copolymerization component is not particularly limited, it is selected from various viewpoints of dispersion stability, compatibility with other monomer components, strength of the formed film, and so on. Preferred examples thereof include methyl (meth)acrylate, n-butyl (meth)acrylate, t-butyl (meth)acrylate, cyclohexyl (meth)acrylate, and styrene.

Though the form of the preferred dispersant of the invention is not particularly limited, it is preferably a block copolymer or a random copolymer, and especially preferably a random copolymer in view of costs and easiness of the synthesis.

Specific examples of the dispersant which is preferably used in the invention will be given below, but it should not be construed that the dispersant of the invention is limited thereto. Incidentally, the dispersants express a random copolymer unless otherwise indicated.

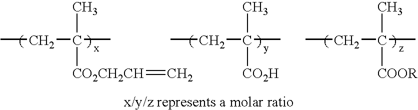

| | x | y | z | R | Mw |
|---|---|---|---|---|---|
| P-(1) | 80 | 20 | 0 | — | 40,000 |
| P-(2) | 80 | 20 | 0 | — | 110,000 |
| P-(3) | 80 | 20 | 0 | — | 10,000 |
| P-(4) | 90 | 10 | 0 | — | 40,000 |
| P-(5) | 50 | 50 | 0 | — | 40,000 |
| P-(6) | 30 | 20 | 50 | CH₂CH₂CH₃ | 30,000 |
| P-(7) | 20 | 30 | 50 | CH₂CH₂CH₂CH₃ | 50,000 |
| P-(8) | 70 | 20 | 10 | CH(CH₃)₃ | 60,000 |
| P-(9) | 70 | 20 | 10 | 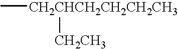 | 150,000 |
| P-(10) | 40 | 30 | 30 | 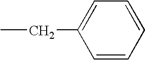 | 15,000 |

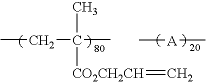

| | A | Mw |
|---|---|---|
| P-(11) | 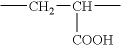 | 20,000 |
| P-(12) | 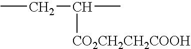 | 30,000 |
| P-(13) | 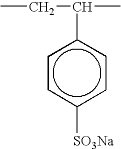 | 100,000 |
| P-(14) | 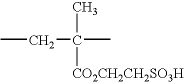 | 20,000 |
| P-(15) | 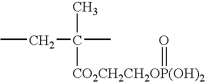 | 50,000 |
| P-(16) | 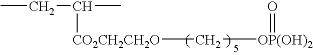 | 15,000 |

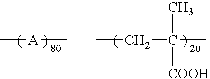

| | A | Mw |
|---|---|---|
| P-(17) | 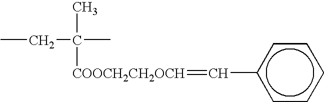 | 20,000 |
| P-(18) | 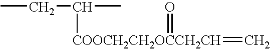 | 25,000 |
| P-(19) | 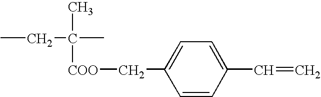 | 18,000 |
| P-(20) | 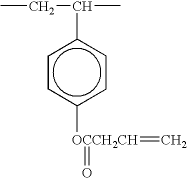 | 20,000 |
| P-(21) | 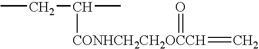 | 35,000 |

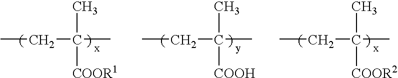

| | R¹ | R² | x | y | z | Mw |
|---|---|---|---|---|---|---|
| P-(22) | 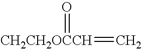 | C₄H₉(n) | 10 | 10 | 80 | 25,000 |
| P-(23) | 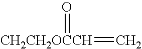 | C₄H₉(t) | 10 | 10 | 80 | 25,000 |
| P-(24) | 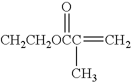 | C₄H₉(n) | 10 | 10 | 80 | 500,000 |
| P-(25) | 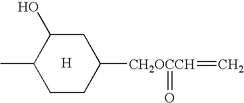 | C₄H₉(n) | 10 | 10 | 80 | 23,000 |
| P-(26) | 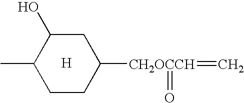 | C₄H₉(n) | 80 | 10 | 10 | 30,000 |
| P-(27) | 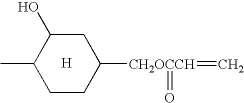 | C₄H₉(n) | 50 | 20 | 30 | 30,000 |
| P-(28) | 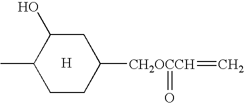 | C₄H₉(t) | 10 | 10 | 80 | 20,000 |
| P-(29) | 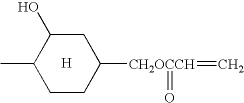 | CH₂CH₂OH | 50 | 10 | 40 | 20,000 |
| P-(30) | 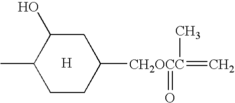 | C₆H₉(n) | 10 | 10 | 80 | 25,000 |

| | | |
|---|---|---|
| P-(31) | 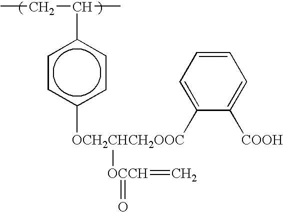 | Mw = 60,000 |
| P-(32) | 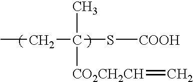 | Mw = 10,000 |
| P-(33) | 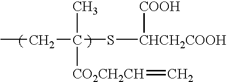 | Mw = 20,000 |
| P-(34) | 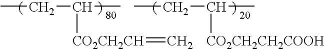 | Mw = 30,000 Block copolymer |
| P-(35) | 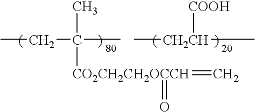 | Mw = 15,000 Block copolymer |
| P-(36) | 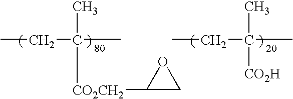 | Mw = 8,000 |
| P-(37) | 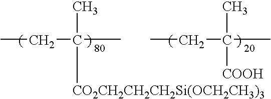 | Mw = 5,000 |
| P-(38) | 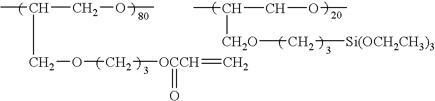 | Mw = 10,000 |

The use amount of the dispersant is preferably in the range of from 1 to 50% by weight, more preferably from 5 to 30% by weight, and most preferably from 5 to 20% by weight based on the inorganic fine particle containing titanium dioxide as the major component. Also, two or more kinds of dispersants may be used jointly.

High Refractive Index Layer and its Formation Method

The inorganic fine particle containing titanium dioxide as the major component, which is used in the high refractive index layer, is used in the state of a dispersion in the formation of the high refractive index layer. In dispersing the inorganic fine particle, the inorganic fine particle is dispersed in a dispersion medium in the presence of the foregoing dispersant.

As the dispersion medium, it is preferred to use a liquid having a boiling point of from 60 to 170° C. Examples of the dispersion medium include water, alcohols (for example, methanol, ethanol, isopropanol, butanol, and benzyl alcohol), ketones (for examnple, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate, and butyl formate), aliphatic hydrocarbons (for example, hexane and cyclohexane), halogenated hydrocarbons (for example, methylene chloride, chloroform, and carbon tetrachloride), aromatic hydrocarbons (for example, benzene, toluene, and xylene), amides (for example, dimethylformamide, dimethyl-acetamide, and n-methylpyrrolidone), ethers (for example, diethyl ether, dioxane, and tetrahydrofuran), and ether alcohols (for example, 1-methoxy-2-propanol). Of these, toluene, xylene, methyl ethyl ketone, methyl isobutyl ketone, cyclohexanone, and butanol are preferable.

The dispersant is especially preferably methyl ethyl ketone, methyl isobutyl ketone, or cyclohexanone.

The inorganic fine particle is dispersed using a dispersion machine. Examples of the dispersion machine include a sand grinder mill (for example, a pin-provided bead mill), a high-speed impeller null, a pebble mill, a roller mill, an attritor, and a colloid mill. Of these, a sand grinder mill and a high-speed impeller mill are especially preferable. Also, a pre-dispersion treatment may be carried out. Examples of a dispersion machine to be used for the pre-dispersion treatment include a ball mill, a three-screw mill, a kneader, and an extruder.

It is preferable that the inorganic fine particle is finely divided in the dispersion medium as far as possible. The weight average size of the fine inorganic particle is from 1 to 200 nm, preferably from 5 to 150 nm, more preferably from 10 to 100 nm, and especially preferably from 10 to 80 nm.

By finely dividing the inorganic fine particle into not more than 200 nm, it is possible to form a high refractive index layer without impairing transparency.

The high refractive index layer to be used in the invention is preferably formed by adding a binder (for example, ionizing radiation-curable polyfunctional monomers or polyfunctional oligomers as enumerated above in the description of the hard coat layer), a photopolymerization initiator, a sensitizer, a coating solvent, and so on to the foregoing dispersion liquid having an inorganic fine particle dispersed in a dispersion medium to prepare a coating solution for forming a high refractive index layer, coating the coating solution for forming a high refractive index layer on the hard coat layer, and curing it by crosslinking reaction or polymerization reaction of an ionizing radiation-curable compound (for example, polyfunctional monomers and polyfunctional oligomers). As specific examples of the binder, photopolymerization initiator, sensitizer, and coating solvent, the compounds enumerated for the hard coat layer can be used.

Further, it is preferable to carry out crosslinking reaction or polymerization reaction of the binder of the high refractive index layer with the dispersant at the same time of or after coating of the layer.

The binder of the thus prepared high refractive index layer is, for example, in the form where the foregoing preferred dispersant and the ionizing radiation-curable polyfunctional monomer or polyfunctional oligomer undergo crosslinking reaction or polymerization reaction, thereby taking an anionic group of the dispersant into the binder. Further, the binder of the high refractive index layer has a function such that the anionic group keeps the dispersed state of the inorganic fine particle, and the crosslinking or polymerization structure imparts a film-forming ability to the binder, thereby improving the physical strength, chemical resistance and weather resistance of the inorganic fine particle-containing high refractive index layer.

The inorganic fine particle has not only an effect for controlling the refractive index of the high refractive index but also a function to suppress cure shrinkage.

In the high refractive index layer, it is preferable that the inorganic fine particle is finely divided as far as possible. The weight average size of the fine inorganic particle is from 1 to 200 nm, preferably from 5 to 150 nm, more preferably from 10 to 100 nm, and most preferably from 10 to 80 nm.

By finely dividing the inorganic fine particle into not more than 200 nm, it is possible to form a high refractive index layer without impairing transparency.

The content of the inorganic fine particle in the high refractive index layer is preferably from 10 to 90% by weight, more preferably from 15 to 80% by weight, and especially preferably from 15 to 75% by weight based on the weight of the high refractive index layer. Two or more kinds of inorganic fine particles may be used jointly within the high refractive index layer.

Since the low refractive index layer is provided on the high refractive index layer, it is preferable that the refractive index of the high refractive index layer is higher than that of the transparent support.

For the high refractive index layer, a binder obtained by crosslinking or polymerization reaction of an aromatic ring-containing ionizing radiation-curable compound, an ionizing radiation-curable compound containing a halogen element other than fluorine (for example, Br, I, and Cl), an ionizing radiation-curable compound containing an atom such as S, N and P, etc. can also be preferably used.

The refractive index of the high refractive index layer is preferably from 1.55 to 2.40, more preferably from 1.60 to 2.20, further preferably from 1.65 to 2.10, and most preferably from 1.80 to 2.00.

For example, in the case where three layers of a medium refractive index layer, a high refractive index layer, and a low refractive index layer are provided in this order on the hard coat layer, the refractive index of the medium refractive index layer is preferably from 1.55 to 1.80; the refractive index of the high refractive index layer is preferably from 1.80 to 2.40; and the high refractive index of the low refractive index layer is preferably from 1.20 to 1.46, respectively.

Besides the foregoing components (for example, an inorganic fine particle, a polymerization initiator, and a photosensitizer), a resin, a surfactant, an antistatic agent, a coupling agent, a thickener, a coloration preventive, a coloring agent (for example, a pigment and a dye), a defoaming agent, a leveling agent, a flame retardant, an ultraviolet ray absorber, an infrared ray absorber, an adhesion imparting agent, a polymerization inhibitor, an antioxidant, a surface modifier, conductive metal fine particles, and so on can be added to the high refractive index layer.

The thickness of the high refractive index layer can be adequately designed depending upon applications. In the case where the high refractive index layer is used as an optical interference layer as described later, the thickness is preferably from 30 to 200 nm, more preferably from 50 to 170 nm, and especially preferably from 60 to 150 nm.

Other Layers of Antireflection Film

For the sake of preparing an antireflection film having a more excellent antireflection performance, it is preferred to provide a medium refractive index layer having a refractive index positioning between the refractive index of the high refractive index layer and the refractive index of the transparent support.

The medium refractive index layer is preferably prepared in the same manner as in the high refractive index layer of the invention, and the refractive index can be adjusted by controlling the content of the inorganic fine particle in the film.

Layers other than those described previously may be provided in the antireflection film. For example, an adhesive layer, a shield layer, a stain-resistant layer, a sliding layer, and an antistatic layer may be provided. The shield layer is provided for the purpose of shielding electromagnetic radiations or infrared rays.

The antireflection film of the invention can be formed according to the following method, but it should not be construed that the invention is limited thereto.

Preparation of Coating Solution

First of all, a coating solution containing components for forming each layer is prepared. During the preparation, by controlling the volatilization amount of the solvent at the minimum level, it is possible to inhibit an increase of the water content in the coating solution. The water content in the coating solution is preferably not more than 5%, and more preferably not more than 2%. The control of the volatilization amount of the solvent can be achieved by enhancing sealing properties at the time of stirring after throwing the respective raw materials into a tank, minimizing the contact area with air of the coating solution at the time of liquid transfer works, and other methods. Also, a measure for reducing the water content in the coating solution during coating or before or after coating may be provided.

It is preferable that the coating solution for forming the hard coat layer is subjected to filtration through which foreign substances corresponding to the dry thickness (from about 50 nm to 120 nm) of the low refractive index layer to be formed directly thereon can be substantially entirely removed (this means an extent of 90% or more). Since the light-transmitting fine particle for imparting light diffusibility is equal to or more than the thickness of the low refractive index layer, it is preferable that the foregoing filtration is applied to an intermediate liquid in which all of raw materials other than the light-transmitting fine particle are added. Also, in the case where a filter capable of removing the foregoing foreign substances having a particle size is not available, it is preferred to achieve filtration such that foreign substances corresponding to the wet thickness (from about 1 to 10 μm) of a layer to be formed at least directly thereon can be substantially entirely removed. By such a measure, it is possible to reduce point failure of the layer to be formed directly thereon.

Coating Method

The respective layers of the antireflection film of the invention can be formed by the following coating methods, but it should not be construed that the invention is limited thereto.

Known methods such as a dip coating method, an air knife coating method, a curtain coating method, a roller coating method, a wire bar coating method, a gravure coating method, an extrusion coating method (see U.S. Pat. No. 2,681,294), and a micro gravure coating method are employable. Of these, a micro gravure coating method is preferable.

The micro gravure coating method to be used in the invention is a coating method characterized in that a gravure roll having a diameter of from about 10 to 100 mm, and preferably from about 20 to 50 mm and marked with a gravure pattern over the whole periphery is rotated beneath the support and reversely in the delivering direction of the support, an excess of the coating solution is scraped off from the surface of the gravure roll by a doctor blade, and a constant amount of the coating solution is coated by transferring it onto the lower surface of the support in the position where the upper surface of the support is in the free state. By continuously unwinding the rolled transparent support, it is possible to coat at least one layer of the hard coat layer and the low refractive index layer containing a fluorine-containing polymer on one side of the unwound support by the micro gravure coating method.

With respect to the coating condition by the micro gravure coating method, the line number of the gravure pattern marked on the gravure roll is preferably from 50 to 800 lines per inch, and more preferably from 100 to 300 lines per inch; the depth of the gravure pattern is from 1 to 600 μm, and more preferably from 5 to 200 μm; the rotation number of the gravure roll is preferably from 3 to 800 rpm, and more preferably from 5 to 200 rpm; and the delivery speed of the support is preferably from 0.5 to 100 m/min, and more preferably from 1 to 50 m/min.

Wet Coating Amount

In forming the hard coat layer, it is preferable that the foregoing coating solution is coated in a thickness as a wet coating film in the range of from 3 to 30 μm on the substrate film directly or via other layer. More preferably, the coating solution is coated in a thickness in the range of from 6 to 20 μm from the viewpoint of preventing drying unevenness. Also, in forming the lower refractive index layer, it is preferable that the coating composition is coated in a thickness as a wet coating film in the range of from 1 to 10 μm on the anti-glare layer directly or via other layer. More preferably, the coating composition is coated in a thickness in the range of from 2 to 5 μm.

Drying

The hard coat layer and the low refractive index layer are coated on the substrate film directly or via other layer and then delivered by a web into a zone heated for drying. In this case, the temperature of the drying zone is preferably from 25° C. to 140° C. Also, it is preferable that the first half of the drying zone is set up at a relatively low temperature, whereas the latter half is set up at a relatively high temperature. However, it is preferable that the temperature is not higher than the temperature at which volatilization of components other than the solvent to be contained in the coating composition of each layer starts. For example, commercially available photo-radical generators which are used jointly with the ultraviolet ray-curing resin include ones in which approximately several tens % thereof is volatilized within several minutes in warm air of 120° C. Also, in some monofunctional or bifunctional acrylate monomers, volatilization proceeds in warm air of 100° C. In such cases, as described previously, it is preferable that the temperature is not higher than the temperature at which volatilization of components other than the solvent to be contained in the coating composition of each layer starts.

Also, with respect to the dry air after coating the coating composition of each layer on the substrate film, for the purpose of preventing drying unevenness from occurring, it is preferable that the air flow rate on the surface of the coating film is in the range of from 0.1 to 2 m/sec during a period of time when the solids content of the foregoing coating composition falls within the range of from 1 to 50%.

Also, after coating the coating composition of each layer on the substrate film, when a difference of the temperature between delivery rolls on the surface of the substrate film opposite to the coating surface and the substrate film is made to fall within the range of from 0° C. to 20° C. in the drying zone, drying unevenness caused due to uneven heat conduction on the delivery rolls can be prevented from occurring, and therefore, such is preferable.

Curing

After the drying zone of the solvent, each coating film is passed through a zone for curing by ionizing radiations and/or heat by the web, thereby curing the coating film. The ionizing radiations to be used in the invention can be used without limitations so far as the compound can be crosslinked and cured by activation with ultraviolet rays, electron beams, γ-rays, etc. Of these, ultraviolet rays and electron beams are preferable; and ultraviolet rays are especially preferable from the standpoints that handling is simple and that high energy is easily obtained. As a light source of ultraviolet rays for photopolymerizing an ultraviolet ray-reactive compound, any light source capable of emitting ultraviolet rays can be used. Examples thereof include a low pressure mercury vapor lamp, a medium pressure mercury vapor lamp, a high pressure mercury vapor lamp, an ultra-fine pressure mercury vapor lamp, a carbon arc lamp, a metal halide lamp, and a xenon lamp. Also, ArF excimer laser, KrF excimer laser, an excimer lamp, and synchrotron radiations can be used. The irradiation condition varies depending upon the respective lamp, and the irradiation dose is preferably 10 mJ/cm² or more, more preferably from 50 Mj/cm² to 10,000 mJ/cm², and especially preferably from 50 mJ/cm² to 2,000 mJ/cm². At this time, with respect to the does distribution in the width direction of the web, a distribution of from 50 to 100% including the both ends against the maximum dose in the center is preferable, and a distribution of from 80 to 100% is more preferable.

The ultraviolet rays may be irradiated whenever one layer of plural layers (i.e., the medium refractive index layer, the high refractive index layer, and the low refractive index layer) constructing the antireflection film is provided or after laminating these layers. Alternatively, the ultraviolet rays may be irradiated by a combination thereof. It is preferable in view of productivity that the ultraviolet rays are irradiated after laminating multiple layers.

Also, in the case of the curing rate of the hard coat layer [100—(residual functional group content)] is a certain value which is less than 100%, when in providing the low refractive index layer of the invention thereon and curing the low refractive index layer by ionizing radiations and/or heat, the curing rate of the hard coat layer as a lower layer becomes higher than that before providing the low refractive index layer, adhesiveness between the hard coat layer and the low refractive index layer is improved, and therefore, such is preferable.

Also, electron beams can be similarly used. Examples of the electron beams include electron beams having energy of from 50 to 1,000 keV, and preferably from 100 to 300 keV, which are released from a variety of electron beam accelerators such as a Cockroft-Walton's type, a van de Graaff type, a resonance transformation type, an insulating core transformer type, a linear type, a dynamitron type, and a high frequency type.

In the case where each layer is formed by crosslinking reaction or polymerization reaction using the foregoing ionizing radiations, it is preferable that the crosslinking reaction or polymerization reaction is carried out in an atmosphere having an oxygen concentration of not more than 10% by volume. By performing the layer formation in an atmosphere having an oxygen concentration of not more than 10% by volume, it is possible to form a layer having excellent physical strength and chemical resistance.

The layer formation is carried out by crosslinking reaction or polymerization reaction of an ionizing radiation-curable compound preferably in an atmosphere having an oxygen concentration of not more 6% by volume, more preferably an oxygen concentration of not more than 4% by volume, especially preferably an oxygen concentration of not more than 2% by volume, and most preferably an oxygen concentration of not more than 1% by volume.

With respect to a measure for adjusting the oxygen concentration at not more than 10% by volume, the atmosphere (nitrogen concentration: about 79% by volume, oxygen concentration: about 21% by volume) is preferably displaced by a separate gas, and especially preferably displaced by nitrogen (purged by nitrogen).

Polarizing Plate

The polarizing plate of the invention comprises a polarizing film and two protective films disposed on the both sides of the polarizing film. As the one-sided protective film, the antireflection film of the invention can be used. As the other protective film, a usual cellulose acetate film may be used. However, it is preferred to use a cellulose acetate film which is produced by the foregoing solution film-forming method and stretched in the widthwise direction in the rolled film state in a stretching degree of from 10 to 100%.

Further, in the polarizing plate of the invention, it is preferable that the other protective film than the antireflection film is an optical compensating film having an optically anisotropic layer comprising a liquid crystalline compound.

Examples of the polarizing film include iodine based polarizing films, dye based polarizing films using a dichroic dye, and polyene based polarizing films. The iodine based polarizing films and dye based polarizing films are generally produced using a polyvinyl alcohol based film.

The slow axis of the transparent support or cellulose acetate film of the antireflection film and the transmission axis of the polarizing film are aligned substantially parallel to each other.

For the productivity of the polarizing plate, moisture permeability of the protective film is important. The polarizing film and the protective film are stuck to each other with an aqueous adhesive. A solvent of this adhesive is diffused in the protective film and dried. As the moisture permeability of the protective film is increased, the drying becomes fast, and the productivity is increased. However, when the moisture permeability of the protective film is excessively increased, the moisture enters the polarizing film to lower the polarizing ability depending upon the use circumference (under high temperatures) of the liquid crystal display.

The moisture permeability of the protective film is determined by the thickness of the transparent support or polymer film (and the polymerizable liquid crystal compound), free volume, hydrophilicity/hydrophobicity, etc.

In the case where the light diffusion film or antireflection film of the invention is used as a protective film of the polarizing plate, the moisture permeability is preferably from 100 to 1,000 g/m²·24 hrs, and more preferably from 300 to 700 g/m²·24 hrs.

In the case of the film formation, the thickness of the transparent support can be adjusted by the lip flow rate and line speed, or by stretching and compression. Since the moisture permeability varies depending upon the principal raw material, it is possible to make the moisture permeability fall within a more preferred range by adjusting the thickness.

In the case of the film formation, the free volume of the transparent support can be adjusted by the drying temperature and time. In this case, since the moisture permeability varies depending upon the principal raw material, too, it is possible to make the moisture permeability fall within a more preferred range by adjusting the free volume.

The hydrophilicity/hydrophobicity of the transparent support can be adjusted by an additive. By adding a hydrophilic additive to the foregoing free volume, the moisture permeability is increased, and conversely, by adding a hydrophobic additive, it is possible to lower the moisture permeability.

By individually controlling the foregoing moisture permeability, it becomes possible to inexpensively produce a polarizing plate having an optically compensatory ability with high productivity.

Optical Compensating Film

The liquid crystal compound which is used in the optically anisotropic layer of the optical compensating film of the invention may be any of a rod-like liquid crystal or a discotic liquid crystal and includes high molecular liquid crystals and low molecular liquid crystals. Further, ones in which a low molecular liquid crystal is crosslinked, whereby no liquid crystallinity is revealed are also included. Of these liquid crystalline compounds, discotic liquid crystals are the most preferable.

Preferred examples of the rod-like liquid crystal include those described in JP-A-2000-304932.

Examples of the discotic liquid crystal include benzene derivatives described in C. Destrade, et al., Mol. Cryst., Vol. 71, page 111 (198 1); truxene derivatives described in C. Destrade, et al., Mol. Cryst., Vol. 122, page 141 (1985) and Physics Lett. A, Vol. 78, page 82 (1990); cyclohexane derivatives described in B. Kolne, et al., Angew. Chem., Vol. 96, page 70 (1984); and azacrown based or phenlylacetylene based macrocyclic compounds described in M. Lehn, et al., Chem. Commun., page 1794 (1985) and J. Zhang, et al., J. Am. Chem. Soc., Vol. 116, page 2655 (1994).

The foregoing discotic liquid crystal generally has a structure in which such a compound constitutes a matrix of the molecular center, and a linear alkyl group or alkoxy group, a substituted benzoyloxy group, or the like is radially substituted and exhibits liquid crystallinity. However, the discotic liquid crystal is not limited to the foregoing materials so far as a molecule itself has a negative uniaxial property and fixed orientation can be imparted.

Also, in the compound having a discotic structure unit in the optically anisotropic layer as referred to in the invention, the compound finally formed in the optically anisotropic layer is not necessarily a discotic compound. For example, those in which the foregoing low molecular discotic liquid crystal has a group reactive with heat, light, etc., consequently, causes polymerization or crosslinking by reaction with heat, light, etc, and becomes to have a high molecular weight, thereby loosing liquid crystallinity, are also included. Preferred examples of the foregoing discotic liquid crystal are described in JP-A-8-50206.

It is preferable that the optically anisotropic layer of the invention is a layer comprising a compound having a discotic structure unit; that the disc plane of the discotic structure unit is slanted to the transparent support plane (that is, the protective film plane); and that an angle between the disc plane of the discotic structure unit and the transparent support plane (that is, the protective film plane) varies in the depth direction of the optically anisotropic layer.

An angle (an angle of inclination) of the plane of the discotic structure unit is generally increased or decreased with an increase a distance from the bottom surface of the optically anisotropic layer in the depth direction of the optically anisotropic layer. It is preferable that the foregoing angle of inclination is increased with an increase of the distance. Further, examples of a change of the angle of inclination include changes including continuous increase, continuous decrease, intermittent increase, intermittent decrease, continuous increase and continuous decrease; and intermittent changes including increase and decrease or the like. The intermittent change includes a region where the angle of inclination does not change on the way of the depth direction. It is preferable that the angle of inclination is increased or decreased as a whole even when a region where the angle of inclination does not change is included. Further, it is preferable that the angle of inclination is increased as a whole, and it is especially preferable that the angle of inclination continuously changes.

The optically anisotropic layer is generally obtained by coating a solution of a discotic compound and other compounds dissolved in a solvent on an orientation film; after drying, heating to a discotic nematic phase-forming temperature; and then cooling while keeping the oriented state (discotic nematic phase). Alternatively, the optically anisotropic layer is obtained by coating a solution of a discotic compound and other compounds (additionally, for example, a polymerizable monomer and a photopolymerization initiator) dissolved in a solvent on an orientation film; after drying, heating to a discotic nematic phase-forming temperature; polymerizing (upon irradiation with UV rays, etc.), and further cooling. The discotic nematic liquid crystal phase-solid phase transition temperature of the discotic liquid crystalline compound to be used in the invention is preferably from 70 to 300° C., and especially preferably from 70 to 170° C.

The angle of inclination of the discotic unit in the support side can be generally adjusted by selecting the material of the orientation film or selecting the rubbing treatment method. Also, the angle of inclination of the discotic unit in the surface side (air side) can be generally adjusted by selecting the discotic compound or other compounds (for example, a plasticizer, a surfactant, a polymerizable monomer, and a polymer) to be used together with the discotic compound. Further, the degree of change of the angle of inclination can also be adjusted by the foregoing selection.

As the foregoing plasticizer, surfactant and polymerizable monomer, any compounds can be used so far as they have compatibility with the discotic compound and can give a change of the angle of inclination of the liquid crystalline discotic compound, or they do not hinder the orientation. Of these, a polymerizable monomer (for example, compounds having a vinyl group, a vinyloxy group, an acryloyl group, or a methacryloyl group) is preferable. The foregoing compounds are generally used in an amount of from 1 to 50% by weight (preferably from 5 to 30% by weight) based on the discotic compound. Further, preferred examples of the polymerizable monomer include polyfunctional acrylates. With respect to the number of functional group, trifunctional or more polyfunctional monomers are preferable, and tetrafunctional or more polyfunctional monomers are more preferable. Of these, hexafunctional monomers are the most preferable. Examples of the hexafunctional monomers include dipentaerythritol hexaacrylate. Also, polyfunctional monomers having the number of functional group different from each other can be used.

As the foregoing polymer, any polymers can be used so far as they have compatibility with the discotic compound and give a change of the angle of inclination to the liquid crystalline discotic compound. Examples of the polymer include cellulose esters. Preferred examples of the cellulose esters include cellulose acetate, cellulose acetate propionate, hydroxypropyl cellulose, and cellulose acetate butyrate. The foregoing polymer is generally used in an amount of from 0.1 to 10% by weight (preferably from 0.1 to 8% by weight, and especially preferably from 0.1 to 5% by weight) based on the discotic compound such that the orientation of the liquid crystalline discotic compound is not hindered.

In the invention, it is preferable that the optically anisotropic layer is made of a discotic liquid crystal formed on an orientation film to be provided on a protective film (for example, a cellulose acetate film), etc. and that the orientation film is a rubbed film made of a crosslinked polymer.

Orientation Film

In the invention, the orientation film to be provided for the purpose of adjusting the orientation of the liquid crystalline compound of the optically anisotropic layer is preferably a layer comprising two kinds of crosslinked polymers. It is preferable that for at least one kind of the two kinds, any one of a polymer which is crosslinkable itself or a polymer which is crosslinked with a crosslinking agent is used. The foregoing orientation film can be formed by allowing functional group-containing polymers or polymers into which a functional group has been introduced to react with each other by the action of light, heat, a pH change, etc., or by introducing a bonding group derived from a crosslinking agent between polymers using a crosslinking agent which is a highly reactive compound, thereby crosslinking the polymers each other.

Such crosslinking is usually carried out by coating a coating solution containing the foregoing polymers or polymers and a crosslinking agent on a transparent support, followed by heating. However, since it is only required that durability can be ensured at a final product stage, the crosslinking may be carried out at any stage until a final polarizing plate is obtained after coating the orientation on the support. In the case where the optically anisotropic layer to be formed on the orientation film is formed of a discotic compound, when the orientation property of the discotic compound is taken into consideration, it is also preferable that the crosslinking is thoroughly carried out after orienting the discotic compound. That is, in the case where a coating solution containing a polymer and a crosslinking agent capable of crosslinking the polymer is coated, the optically anisotropic layer is formed by after heat drying (though crosslinking is generally carried out, in the case where the heating temperature is low, when heated to the discotic nematic phase-forming temperature, the crosslinking further proceeds), undergoing a rubbing treatment to form an orientation film, coating a coating solution containing a compound having a disc-like structural unit on the orientation film, heating to a temperature of the discotic nematic phase-forming temperature or higher, and then cooling.

In the invention, as the polymer to be used in the orientation film, all of polymers which are crosslinkable themselves and polymers which are crosslinked with a crosslinking agent can be used. As a matter of course, polymers having both properties can be used. Examples of the foregoing polymer include polymers such as polymethyl methacrylate, an acrylic acid/methacrylic acid copolymer, a styrene/mallein imide copolymer, polyvinyl alcohol and a modified polyvinyl alcohol, poly(N-methylolacrylamide), a styrene/vinyltoluene copolymer, chloro-sulfonated polyethylene, a nitrocellulose, polyvinyl chloride, chlorinated polyolefins, polyesters, polyimides, a vinyl acetate/vinyl chloride copolymer, an ethylene/vinyl acetate copolymer, carboxymethyl cellulose, polyethylene, polypropylene, polycarbonates, and gelatin; and compounds such as silane coupling agents. Of these polymers, water-soluble polymers such as poly(N-methylolacrylamide), carboxymethyl cellulose, gelatin, polyvinyl alcohol, and a modified polyvinyl alcohol are preferable; gelatin, polyvinyl alcohol, and a modified polyvinyl alcohol are more preferable; and polyvinyl alcohol and a modified polyvinyl alcohol are especially preferable.

Of the foregoing polymers, polyvinyl alcohol or a modified polyvinyl alcohol is preferable; and a combination of two kinds of polyvinyl alcohols or modified polyvinyl alcohols having a different degree of polymerization is the most preferable.

The polyvinyl alcohol is, for example, one having a degree of saponification of from 70 to 100%, generally one having a degree of saponification of from 80 to 100%, and more preferably one having a degree of saponification of from 85 to 95%. Examples of the modified polyvinyl alcohols include modified products of polyvinyl alcohols such as ones modified by copolymerization (for example, COONa, Si(OX)₄, N(CH₃)₃.Cl, C₉H₁₉COO, SO₃, Na, C₁₂H₂₅, or the like is introduced as a modified group); ones modified by chain transfer (for example, COONa, SH, C₁₂H₂₅, or the like is introduced as a modified group); and ones modified by block polymerization (for example, COOH, CONH₂, COOR, C₆H₅, or the like is introduced as a modified group). Of these, unmodified or modified polyvinyl alcohols having a degree of saponification of from 80 to 100% are preferable; and unmodified or alkylthio-modified polyvinyl alcohols having a degree of saponification of from 85 to 95% are more preferable.

The synthesis method, measurement of visible absorption spectrum, method of determining a degree of introduction of these modified polymers are described in detail in JP-A-8-338913.

Specific examples of the crosslinking agent which is used together with the foregoing polymer such as polyvinyl alcohol include ones enumerated below, and these are preferable in the case of using together with the foregoing water-soluble polymer, especially polyvinyl alcohol and a modified polyvinyl alcohol (including the modification products as specified above). That is, specific examples of the crosslinking agent include aldehydes (for example, formaldehyde, glyoxal, and glutaledhyde); N-methylol compounds (for example, dimethylolurea and methyloldimethyl hydantoin); dioxane derivatives (for example, 2,3-dihydroxydioxane), compounds which act upon activation of a carboxyl group (for example, carbeniun, 2-naphthalene sulfonate, 1,1-bispyrrolidino-1-chloropyridinium, and 1-morpholinocarbonyl-3-(sulfonatoaminomethyl); active vinyl compounds (for example, 1,3,5-triacryloyl-hexahydro-s-triazine, bis(vinylsulfone)methane, and N,N′-methylenebis-[β-(vinylsulfonyl)propionamide]); active halogen compounds (for example, 2,4-dichloro-6-hydroxy-s-triazine); isoxazoles; and dialdehyde starches. These crosslinking agents can be used singly or in combinations. In the case where the productivity is taken into consideration, use of an aldehyde having high reaction activity, especially glutaldehyde is preferable.

There are no particular limitations regarding the crosslinking agent. With respect to the addition amount of the crosslinking agent, the moisture resistance tends to be improved as the addition amount is increased. However, in the case where the crosslinking agent is added in an amount of 50% by weight or more based on the polymer, an orientation ability as the orientation film is lowered. Accordingly, the addition amount of the crosslinking agent is preferably from 0.1 to 20% by weight, and especially preferably from 0.5 to 15% by weight. In this case, the orientation film may possibly contain the unreacted crosslinking agent to some extent even after completion of the crosslinking reaction. Thus, the amount of the crosslinking agent is preferably not more than 1.0% by weight, and especially preferably not more than 0.5% by weight in the orientation film. When the crosslinking agent is contained in an amount exceeding 1.0% by weight in the orientation film, sufficient durability is not obtained. That is, in the case of using in a liquid crystal display, when the liquid crystal display is used over a long period of time or allowed to stand in a high-temperature and high-humidity atmosphere, reticulation may possibly be generated.

The orientation film of the invention can be formed by coating a coating solution containing the foregoing polymer and crosslinking agent as the orientation film-forming materials on a transparent support, heat drying (crosslinking), and then rubbing. The crosslinking reaction may be carried out at an arbitrary timing after coating on the transparent support as described previously. In the case where the foregoing water-soluble polymer such as polyvinyl alcohol is used as the orientation film-forming material, the coating solution is preferably a solution in a mixed solvent of an organic solvent such as methanol having a defoaming action and water. Its ratio is generally from 0/100 to 99/1, and preferably from 0/100 to 91/9 in terms of weight ratio. In this way, the generation of foams is suppressed, and defects of the orientation film, and additionally the layer surface of the optically anisotropic layer are remarkably reduced. Examples of the coating method include a spin coating method, a dip coating method, a curtain coating method, an extrusion coating method, a bar coating method, and an E-type coating method. Of these, an E-type coating method is especially preferable. Also, the film thickness is preferably from 0.1 to 10 μm.

The heat drying can be carried out at from 20° C. to 110° C. For the sake of forming sufficient crosslinking, the heat drying temperature is from 60° C. to 100° C., and especially preferably from 80° C. to 100° C. The heat drying can be carried out for a period of time of from one minute to 36 hours, and preferably from 5 minutes to 30 minutes. The pH is preferably set up at a value optimum for the crosslinking agent to be used. In the case where glutaldehyde is used as the crosslinking agent, the pH is preferably from 4.5 to 5.5. and especially preferably 5.

The orientation film is provided on the transparent support or via an undercoating layer capable of making the transparent support adhere closely to the orientation film. The undercoating layer is not particularly limited so far as in a combination of the transparent support and the orientation film, the adhesion therebetween can be enhanced.

The orientation film can be obtained by crosslinking the polymer layer as described previously and rubbing the surface. The orientation film functions so as to define the orientation direction of the liquid crystalline discotic compound to be provided thereon.

For the rubbing treatment, a treatment method which is broadly employed as a treatment step of orienting a liquid crystal of LCD can be utilized. That is, there is employable a method of obtaining orientation by rubbing the surface of the orientation film in a fixed direction using paper, gauze, felt, rubber, nylon or polyester fibers, etc. In general, the rubbing is carried out several times by using, for example, a cloth averagely transplanted with fibers having uniform length and thickness.

Transparent Support on which the Optically Anisotropic Layer is Provided

The transparent support on which the optically anisotropic layer is provided is preferably a cellulose acetate film and may be optically uniaxial or biaxial.

Since the transparent support on which the optically anisotropic layer is provided plays itself an optically important role, the transparent support is preferably adjusted so as to have an Re retardation value of from 0 to 200 nm and an Rth retardation value of from 70 to 400 nm.

In the case where two sheets of optically anisotropic cellulose acetate film are used in a liquid crystal display, the Rth retardation value of the film is preferably from 70 to 250 nm.

In the case where one sheet of optically anisotropic cellulose acetate film is used in a liquid crystal display, the Rth retardation value of the film is preferably from 150 to 400 nm.

Incidentally, a birefringence index (Δn: nx−ny) of the cellulose acetate film is preferably from 0.00 to 0.002. Also, a birefringence index {(nx+ny)/2−nz} of the cellulose acetate film in the thickness direction is preferably from 0.001 to 0.04.

Incidentally, the retardation value (Re) is calculated according to the following expression (2).
Re retardation value=(nx−ny)×d Expression (2)

In the foregoing expression, nx represents a refractive index in the slow axis direction within the plane of the phase difference plate (maximum refractive index within the plane); ny represents a refractive index in the vertical direction to the slow axis within the plane of the phase differential plate; and d represents a thickness (unit: nm) of the film.

Also, the Rth retardation value is calculated according to the following expression (3).
Rth retardation value={(nx+ny)/2−nz}×d Expression (3)

In the foregoing expression, nx represents a refractive index in the slow axis direction (the direction giving the maximum refractive index) within the plane of the film; ny represents a refractive index in the fast axis direction (the direction giving the minimum refractive index) within the plane of the film; nz represents a refractive index in the thickness direction of the film; and d represents a thickness (unit: nm) of the film.

Liquid Crystal display

The antireflection film or polarizing plate of the invention can be advantageously used in an image display such as a liquid crystal display and is preferably used in the most superficial layer of the display.

The liquid crystal display has a liquid crystal cell and two sheets of polarizing plate aligned on the both sides thereof. The liquid crystal cell carries a liquid crystal between two sheets of electrode substrate. Further, one sheet of optically anisotropic layer is aligned between the liquid crystal cell and the one-sided polarizing plate, or two sheets of optically anisotropic layer may possibly be aligned between the liquid crystal cell and each of the polarizing plates.

The liquid crystal cell is preferably a TN mode, a VA mode, an OCB mode, an IPS mode, or an ECB mode.

In the liquid crystal cell of a TN mode, rod-like liquid crystalline molecules are substantially horizontally oriented at the time when no voltage is applied and further twisted and oriented at an angle of from 60 to 120°.

The liquid crystal cell of a TN mode is most frequently utilized in a color TFT liquid crystal display and described in many documents.

In the liquid crystal cell of a VA mode, rod-like liquid crystalline molecules are substantially vertically oriented at the time when no voltage is applied.

The liquid crystal cell of a VA mode includes (1) a liquid crystal cell of a VA mode in a narrow sense in which rod-like liquid crystalline are substantially vertically oriented at the time when no voltage is applied and substantially horizontally oriented at the time when a voltage is applied (described in JP-A-2-176625); (2) a liquid crystal cell of an MVA mode in which a VA mode is modified to be a multi-domain type so as to enlarge the viewing angle (described in SID97, Digest of Tech. Papers, 28 (1997), 845); (3) a liquid crystal cell of an n-ASM mode in which rod-like liquid crystalline molecules are substantially vertically oriented when no voltage is applied and oriented in a twisted multi-domain type when a voltage is applied (described in Nippon Ekisho Toronkai [Liquid Crystal Forum of Japan], Digest of Tech. Papers, 58-59 (1998)); and (4) a liquid crystal cell of a SURVAIVAL mode (reported in LCD International 98).

The liquid crystal cell of an OCB mode is a liquid crystal cell of a bend orientation mode in which rod-like liquid crystalline molecules are substantially reversely (symmetrically) oriented in the upper and lower portions and is described in U.S. Pat. Nos. 4,583,825 and 5,410,422. Since the rod-like liquid crystalline molecules are symmetrically oriented in the upper and lower portions of the liquid crystal cell, the liquid crystal cell of a bend orientation mode has a self-optically compensatory ability. For this reason, this liquid crystal mode is called an OCB (optically compensatory bend) liquid crystal mode. A liquid crystal display of a bend orientation mode has such an advantage that the response speed is fast.

The liquid crystal cell of an EPS mode is of a mode in which switching is performed while applying a transverse electric field to a nematic liquid crystal and is described in detail in Proc. IDRC (Asia Display '95), pp. 577-580 and ibid., pp. 707-710.

In the liquid crystal cell of an ECB mode, rod-like liquid crystalline molecules are substantially horizontally oriented at the time when no voltage is applied. The ECB mode is one of liquid crystal display modes having the simplest structure and is described in, for example, JP-A-5-203946.

### EXAMPLES

The invention will be specifically described below with reference to the following Examples, but it should not be construed that the invention is limited thereto.

### Example 1

Preparation of Coating Solution A for Hard Coat Layer

The following composition was thrown into a mixing tank and stirred to prepare a coating solution A for hard coat layer.

Composition of Coating Solution A for Hard Coat Layer

| | | |
|---|---|---|
| DeSolite Z7404: | 100 | weight parts |
| (Zirconia fine particle-containing composition | | |
| liquid: solids content, 60 wt %; zirconia fine particle | | |
| content, 70 wt % based on the solids; average | | |
| particle size, about 20 nm; solvent composition, | | |
| MIBK/MEK = 9/1, manufactured by JSR | | |
| Corporation) | | |
| DPHA: | 31 | weight parts |
| (UV-curable resin, manufactured by Nippon | | |
| Kayaku Co., Ltd.) | | |
| KBM-5103: | 10 | weight parts |
| (Silane coupling agent, manufactured by | | |
| Shin-Etsu Chemical Co., Ltd.) | | |
| KE-P150: | 8.9 | weight parts |
| (1.5 μm silica particle, manufactured by | | |
| Nippon Shokubai Co., Ltd.) | | |
| MXS-300: | 3.4 | weight parts |
| (3.0 μm crosslinked PMMA particle, | | |
| manufactured by Soken Chemical & | | |
| Engineering Co., Ltd.) | | |
| Methyl ethyl ketone (MEK): | 29 | weight parts |
| Methyl isobutyl ketone (MIBK): | 13 | weight parts |

Incidentally, the foregoing “1.5 μm silica particle” means a silica particle having an average particle size of 1.5 μm; and the “3.0 μm crosslinked PMMA particle” means a crosslinked polymethyl methacrylate particle having an average particle size of 3.0 μm. These particles are a light-transmitting particle.

Preparation of Coating Solution B for Hard Coat Layer

The following composition was thrown into a mixing tank and stirred to prepare a coating solution B for hard coat layer.

| | | |
|---|---|---|
| DeSolite Z7404: | 100 | weight parts |
| (Zirconia fine particle-containing composition | | |
| liquid: solids content, 60 wt %; zirconia fine | | |
| particle content, 70 wt % based on the solids; | | |
| average particle size,about 20 nm; solvent | | |
| composition, MIBK/MEK = 9/1, | | |
| manufactured by JSR Corporation) | | |
| DPHA: | 31 | weight parts |
| (UV-curable resin, manufactured by Nippon Kayaku | | |
| Co., Ltd.) | | |
| KBM-5103: | 10 | weight parts |
| (Silane coupling agent, manufactured by Shin-Etsu | | |
| Chemical Co., Ltd.) | | |
| KE-P150: | 4.3 | weight parts |
| (1.5 μm silica particle, manufactured by Nippon | | |
| Shokubai Co., Ltd.) | | |
| Methyl ethyl ketone (MEK): | 29 | weight parts |
| Methyl isobutyl ketone (MIBK): | 13 | weight parts |

Preparation of Dispersion Liquid of Titanium Dioxide Fine Particle

A titanium dioxide fine particle (MPT-129C, manufactured by Ishihara Sangyo Kaisha, Ltd.) containing cobalt and having been subjected to a surface treatment with aluminum hydroxide and zirconium hydroxide were used as the titanium dioxide fine particle.

38.6 g of the following dispersant and 704.3 g of cyclohexanone were added to 257.1 g of this particle, and the mixture was dispersed by a dyno-mill to prepare a titanium dioxide dispersion liquid having a weight average particle size of 70 nm. 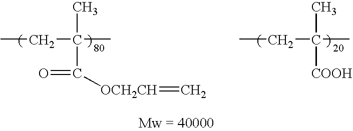
Preparation of Coating Solution for Medium Refractive Index Layer

The following composition was thrown into a mixing tank and stirred, and then filtered by a polypropylene-made filter having a pore size of 0.4 μm to prepare a coating solution for medium refractive index layer.

Composition of Coating Solution for Medium Refractive Index Layer

| | | |
|---|---|---|
| Dispersion liquid of | 100 | weight parts |
| titanium dioxide fine particle: | | |
| DPHA: | 66 | weight parts |
| (UV-curable resin, manufactured by | | |
| Nippon Kayaku Co., Ltd.) | | |
| IRGACURE 907: | 3.5 | weight parts |
| (Photopolymerization initiator, | | |
| manufactured by Ciba-Geigy AG) | | |
| KAYACURE DETX: | 1.2 | weight parts |
| (Photosensitizer, manufactured | | |
| by Nippon Kayaku Co., Ltd.) | | |
| Methyl ethyl ketone (MEK): | 543 | weight parts |
| Cyclohexanone: | 2,103 | weight parts |

Preparation of Coating Solution for High Refractive Index Layer

The following composition was thrown into a mixing tank and stirred, and then filtered by a polypropylene-made filter having a pore size of 0.4 μm to prepare a coating solution for high refractive index layer.

Composition of Coating Solution for Medium Refractive Index Layer

| | | |
|---|---|---|
| Dispersion liquid of | 100 | weight parts |
| titanium dioxide fine particle: | | |
| DPHA: | 8.2 | weight parts |
| (UV-curable resin, manufactured by | | |
| Nippon Kayaku Co., Ltd.) | | |
| IRGACURE 907: | 0.68 | weight parts |
| (Photopolymerization initiator, manufactured | | |
| by Ciba-Geigy AG) | | |
| KAYACURE DETX: | 0.22 | weight parts |
| (Photosensitizer, manufactured by | | |
| Nippon Kayaku Co., Ltd.) | | |
| Methyl ethyl ketone (MEK): | 78 | weight parts |
| Cyclohexanone: | 243 | weight parts |
| Preparation of sol liquid a | | |

In a reactor equipped with a stirrer and a reflux condenser, 120 parts by weight of methyl ethyl ketone, 100 parts by weight of acryloyloxypropyl trimethoxysilane (KBM-5103 (a trade name), manufactured by Shin-Etsu Chemical Co., Ltd.), and 3 parts by weight of diisopropoxyaluninum ethyl acetoacetate were added and mixed, to which was then added 30 parts by weight of ion-exchanged water, and the mixture was allowed to react at 60° C. for 4 hours. Thereafter, the reaction mixture was cooled to room temperature to obtain a sol liquid a. The weight average molecular weight was 1,800, and of the components of oligomer and polymer components, components having a molecular weight of from 1,000 to 20,000 were present in a proportion of 100%. Also, the gas chromatographic analysis revealed that the starting acryloyloxypropyl trimethoxysilane did not remain at all. Synthesis of perfluoroolefin copolymer (1)

A stainless steel-made stirrer-equipped autoclave having an inner volume of 100 mL was charged with 40 mL of ethyl acetate, 14.7 g of hydroxyethyl vinyl ether, and 0.55 g of of dilauroyl peroxide, and the system was deaerated and then purged with a nitrogen gas. Further, 25 g of hexafluoropropylene (HFP) was introduced into the autoclave, and the temperature was raised to 65° C. At the time when the temperature within the autoclave reached 65° C., the pressure was 0.53 MPa (5.4 kg/cm²). The reaction was continued for 8 hours while keeping that temperature. At the time when the pressure reached 0.31 MPa (3.2 kg/cm²), the heating was stopped, and the system was then allowed to stand for cooling. At the time when the internal temperature dropped to room temperature, the unreacted monomers were turned out, the autoclave was opened, and the reaction mixture was discharged. The resulting reaction mixture was thrown into a large excess of hexane, and the solvent was removed by decantation to take out a precipitated polymer. Further, this polymer was dissolved in a small amount of ethyl acetate and re-precipitated from hexane twice, thereby completely removing the residual monomers. After drying, there was obtained 28 g of a polymer. Next, 20 g of this polymer was dissolved in 100 mL of N,N-dimethylacetamide, to which was then dropped 11.4 g of acrylic chloride under ice cooling, and the mixture was stirred at room temperature for 10 hours. Ethyl acetate was added to the reaction mixture, the mixture was washed with water, and the organic layer was extracted and then concentrated. The resulting polymer was re-precipitated from hexane to obtain 19 g of a perfluoroolefin copolymer (1). The resulting polymer had a refractive index of 1.421. 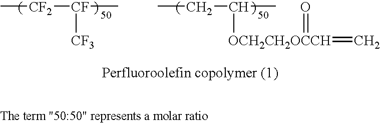
Preparation of Hollow Silica Fine Particle Dispersion Liquid

30 parts of acryloyloxypropyl trimethoxysilane (KBM-5103, manufactured by Shin-Etsu Chemical Co., Ltd.) and 1.5 parts of diisopropoxyaluninum ethyl acetate were added to 500 parts of a hollow silica fine particle sol (an isopropyl alcohol silica sol, CS60-IPA, manufactured by Catalysts & Chemicals Ind. Co., Ltd., average particle size: 60 nm, shell thickness: 10 nm, silica concentration: 20%, refractive index of silica particle: 1.31), and after mixing, 9 parts of ion-exchanged water was added. The mixture was allowed to react at 60° C. for 8 hours, and the reaction mixture was cooled to room temperature, to which was then added 1.8 parts of acetylacetone, to obtain a hollow silica dispersion liquid. The resulting hollow silica dispersion liquid had a solids content of 18% by weight and a refractive index after drying the solvent of 1.31.

Preparation of Coating Solution A for Low Refractive Index Layer

The following composition was thrown into a mixing tank and stirred, and then filtered by a polypropylene-made filter having a pore size of 1 μm to prepare a coating solution A for low refractive index layer.

Composition of Coating Solution A for Low Refractive Index Layer

| | | |
|---|---|---|
| DPHA: | 1.4 | weight parts |
| (UV-curable resin, manufactured by | | |
| Nippon Kayaku Co., Ltd.) | | |
| Perfluoroolefin copolymer (1) | 5.6 | weight parts |
| Hollow silica fine particle | 20.0 | weight parts |
| dispersion liquid: | | |
| RMS-033: | 0.7 | weight parts |
| (Reactive silicone, manufactured by | | |
| Gelest, Inc.) | | |
| IRGACURE 907: | 0.2 | weight parts |
| (Photopolymerization initiator, manufactured by | | |
| Ciba-Geigy AG) | | |
| Sol liquid a: | 6.2 | weight parts |
| Methyl ethyl ketone (MEK): | 306.9 | weight parts |
| Cyclohexanone: | 9.0 | weight parts |

Preparation of Coating Solution B for Low Refractive Index Layer

The following composition was thrown into a mixing tank and stirred, and then filtered by a polypropylene-made filter having a pore size of 1 μm to prepare a coating solution B for low refractive index layer.

Composition of Coating Solution B for Low Refractive Index Layer

| | | |
|---|---|---|
| DPHA: | 1.4 | weight parts |
| (UV-curable resin, manufactured by | | |
| Nippon Kayaku Co., Ltd.) | | |
| Perfluoroolefin copolymer (1): | 5.6 | weight parts |
| Silica fine particle dispersion: | 12.0 | weight parts |
| (Product having a different particle size from | | |
| MEK-ST, manufactured by Nissan Chemical | | |
| Industries, Ltd., average particle size: 45 nm) | | |
| RMS-033: | 0.7 | weight parts |
| (Reactive silicone, manufactured by Gelest, Inc.) | | |
| IRGACURE 907: | 0.2 | weight parts |
| (Photopolymerization initiator, manufactured | | |
| by Ciba-Geigy AG) | | |
| Sol liquid a: | 6.2 | weight parts |
| Methyl ethyl ketone (MEK): | 306.9 | weight parts |
| Cyclohexanone: | 9.0 | weight parts |

Preparation of Coating Solution C for Low Refractive Index Layer

The following composition was thrown into a mixing tank and stirred, and then filtered by a polypropylene-made filter having a pore size of 1 μm to prepare a coating solution C for low refractive index layer.

Composition of Coating Solution C for Low Refractive Index Layer

| | | |
|---|---|---|
| Perfluoroolefin copolymer (1): | 13.4 | weight parts |
| RMS-033: | 0.7 | weight parts |
| (Reactive silicone, manufactured by Gelest, Inc.) | | |
| IRGACURE 907: | 0.2 | weight parts |
| (Photopolymerization initiator, manufactured | | |
| by Ciba-Geigy AG) | | |
| Methyl ethyl ketone (MEK): | 306.9 | weight parts |
| Cyclohexanone: | 9.0 | weight parts |

Preparation of Antireflection Film A-01

A cellulose triacetate film having a thickness of 80 μm (TD80U, manufactured by Fuji Photo Film Co., Ltd.) as a support was unwound in the rolled state. The foregoing coating solution A for hard coat layer was coated on the support under a condition of a delivery speed of 10 in/min using a micro gravure roll having a diameter of 50 mm and having a gravure pattern having the line number of 135 lines/inch and a depth of 60 μm and a doctor blade and dried at 60° C. for 150 seconds. Further, the coated layer was cured upon irradiation with ultraviolet rays having an illuminance of 400 mW/cm² and a dose of 250 mJ/cm² using a 160 W/cm air-cooled metal halide lamp (manufactured by Eyegraphics Co., Ltd.) while purging with nitrogen, to form a hard coat layer 1, followed by winding up. After curing, the rotation number of the gravure roll was adjusted such that the thickness of the hard coat layer was 3.5 μm.

The zirconia fine particle-containing binder, the 1.5 μm silica particle, and the 3.0 μm crosslinked PMMA particle, all of which constructed the hard coat layer 1, had a refractive index of 1.62, 1.44 and 1.49, respectively.

The support having been provided with the foregoing hard coat layer 1 was again unwound. The foregoing coating solution A for low refractive index layer was coated on the support under a condition of a delivery speed of 10 m/min using a micro gravure roll having a diameter of 50 mm and having a gravure pattern having the line number of 180 lines/inch and a depth of 40 μm and a doctor blade and dried at 120° C. for 150 seconds. After further drying at 140° C. for 8 minutes, the coated layer was cured upon irradiation with ultraviolet rays having an illuminance of 400 mW/cm² and a dose of 900 mJ/cM² using a 240 W/cm air-cooled metal halide lamp (manufactured by Eyegraphics Co., Ltd.) while purging with nitrogen, to form a low refractive index layer 1, followed by Winding up. After curing, the rotation number of the gravure roll was adjusted such that the thickness of the low refractive index layer was 100 nm.

Preparation of Antireflection Films A-02 to A-05

Antireflection films A-02, A-03, A-04 and A-05 were prepared in the same manner as in the preparation of the antireflection film A-01, except that the addition amount of KE-P150 (1.5 μm silica particle) of the coating solution A for hard coat layer was changed to 7.0 parts by weight, 4.6 parts by weight, 2.1 parts by weight, and 0 part by weight (not added) to form hard coat layers 2, 3, 4 and 5, respectively.

Preparation of Antireflection Films A-06 to A-08

Antireflection films A-06, A-07 and A-08 were prepared in the same manner as in the preparation of the antireflection film A-01, except that the addition amount of KE-P150 (1.5 μm silica particle) of the coating solution A for hard coat layer was changed to 4.6 parts by weight and that the thickness of the hard coat layer was changed to 3.2 μm, 3.0 μm and 2.7 μm to form hard coat layers 6, 7 and 8, respectively. In the antireflection films A-08, the film thickness was thin, and an irregular structure by the 3.0 μm crosslinked PMMA particle was formed on the surface of the hard coat layer. As a result, the surface roughness Ra of the antireflection films was respectively 0.12 μm and 0.15 μm and exceeded 0.10 μm. Thus, the antireflection films A-07 and A-08 are a comparative examnple.

Preparation of Antireflection Film A-09

An antireflection film A-09 was prepared in the same manner as in the preparation of the antireflection film A-01, except for using the coating solution B for hard coat layer to prepare a hard coat layer 9.

The zirconia fine particle-containing binder and the 1.5 μm silica particle, all of which constructed the hard coat layer 9, had a refractive index of 1.62 and 1.44, respectively.

Preparation of Antireflection Films A-10 and A-11

Antireflection films A-10 and A-11 were prepared in the same manner as in the preparation of the antireflection film A-01, except that the addition amount of KE-P150 (1.5 μm silica particle) of the coating solution B for hard coat layer was changed to 2.0 parts by weight and 0 part by weight (not added) to form hard coat layers 10 and 11, respectively. The antireflection film A-11 does not contain a light-transmitting particle in the hard coat layer and is a comparative example.

Preparation of Antireflection Films A-12 and A-13

Antireflection films A-12 and A-13 were prepared in the same manner as in the preparation of the antireflection films A-03 and A-09, respectively, except for forming a low refractive index layer 2 on each of the hard coat layers 3 and 9 using the foregoing coating solution B for low refractive index layer. These antireflection films do not contain a hollow silica particle in the low refractive index layer and are a comparative example.

Preparation of Antireflection Films A-14 and A-15

Antireflection films A-14 and A-15 were prepared in the same manner as in the preparation of the antireflection films A-03 and A-09, respectively, except for forming a low refractive index layer 3 on each of the hard coat layers 3 and 9 using the foregoing coating solution C for low refractive index layer. These antireflection films do not contain a hollow silica particle in the low refractive index layer and are a comparative example.

Preparation of Antireflection Film A-16

An antireflection film A-16 not provided with a low refractive index layer was prepared in the same manner as in the preparation of the antireflection film A-09 by forming only the hard coat layer 9 (comparative example).

Preparation of Antireflection Film A-17

A cellulose triacetate film having a thickness of 80 μm (TD80U, manufactured by Fuji Photo Film Co., Ltd.) as a support was unwound in the rolled state. The foregoing coating solution B for hard coat layer was coated on the support using a gravure coater. After drying at 100° C., the coated layer was cured upon irradiation with ultraviolet rays having an illuminance of 400 mW/cm² and a dose of 300 mJ/cm² using a 160 W/cm air-cooled metal halide lamp (manufactured by Eyegraphics Co., Ltd.) while purging with nitrogen such that the atmosphere had an oxygen concentration of not more than 1.0% by volume, to form a hard coat layer 12 having a thickness of 3.5 μm.

The coating solution for medium refractive index layer was coated on the hard coat layer 12 using a gravure coater. After drying at 100° C., the coated layer was cured upon irradiation with ultraviolet rays having an illuminance of 550 mW/cm² and a dose of 600 mJ/cm² using a 240 W/cm air-cooled metal halide lamp (manufactured by Eyegraphics Co., Ltd.) while purging with nitrogen such that the atmosphere had an oxygen concentration of not more than 1.0% by volume, to form a medium refractive index layer (refractive index: 1.65, thickness: 67 nm).

The coating solution for high refractive index layer was coated on the medium refractive index layer using a gravure coater. After drying at 100° C., the coated layer was cured upon irradiation with ultraviolet rays having an illuminance of 550 mW/cm² and a dose of 600 mJ/cm² using a 240 W/cm air-cooled metal halide lamp (manufactured by Eyegraphics Co., Ltd.) while purging with nitrogen such that the atmosphere had an oxygen concentration of not more than 1.0% by volume, to form a high refractive index layer (refractive index: 1.93, thickness: 107 nm).

The coating solution A for low refractive index layer was coated on the high refractive index layer using a gravure coater. After drying at 80° C., the coated layer was cured upon irradiation with ultraviolet rays having an illuminance of 550 mW/cm² and a dose of 600 mJ/cm² using a 160 W/cm air-cooled metal halide lamp (manufactured by Eyegraphics Co., Ltd.) while purging with nitrogen such that the atmosphere had an oxygen concentration of not more than 1.0% by volume, to form a low refractive index layer (refractive index: 1.43, thickness: 86 nm). In this way, an antireflection layer 3 was formed on the hard coat layer to prepare an antireflection film A-17.

Preparation of Antireflection Films A-18 and A-19

Antireflection films A-18 and A-19 were prepared in the same manner as in the preparation of the antireflection film A-09, except that the IRGACURE 907 to be contained in the coating solution A for low refractive index layer was replaced by IRGACURE 184 (photopolymerization initiator, manufactured by Ciba-Geigy AG) or Illustrative Compound 21.

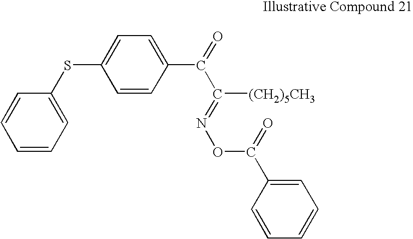

Further, with respect to a series of the antireflection films A-01 to A-19, a cellulose triacetate film prepared by replacing TINUVIN 327 (UV absorber, manufactured by Ciba Specialty Chemicals) to be contained in TD80U as the support by TINUVIN 326 (UV absorber, manufactured by Ciba Specialty Chemicals) was used for the RD80U, thereby preparing antireflection films B-01 to B-19.

Saponification Treatment of Antireflection Film

A 1.5 moles/L sodium hydroxide aqueous solution was prepared and kept at 55° C. A 0.005 moles/L dilute sulfuric acid aqueous solution was prepared and kept at 35° C. The prepared antireflection film was dipped in the foregoing sodium hydroxide aqueous solution for 2 minutes and then dipped in water to thoroughly wash off the sodium hydroxide aqueous solution. Next, the resulting antireflection film was dipped in the foregoing dilute sulfuric acid aqueous solution for one minute and then dipped in water to thoroughly wash off the dilute sulfuric acid aqueous solution. Finally, the sample was thoroughly dried at 120° C.

There was thus prepared a saponified antireflection film.

Preparation of Antireflection film-Provided Polarizing Plates PA-01 to PA-17

Iodine was adsorbed on a stretched polyvinyl alcohol film to prepare a polarizing film. Each of the saponified antireflection films A-01 to A-17 was stuck onto one side of the polarizing film using a polyvinyl alcohol based adhesive in such a manner that the support side (triacetyl cellulose) of the antireflection film became the polarizing film side. Also, a viewing angle enlarging film (Wide View Film Super Ace, manufactured by Fuji Photo Film Co., Ltd.) comprising an optically compensatory layer, in which the disc plane of the discotic structure unit was slanted to the plane of the film and an angle between the disc plane of the discotic structure unit and the plane of the film varied in the depth direction of the optically anisotropic layer, was stuck onto the other side of the polarizing film using a polyvinyl alcohol based adhesive. There were thus prepared polarizing plates PA-01 to PA-17.

Evaluation of Antireflection Films and Polarizing Films

The obtained antireflection films and polarizing plates were evaluated with respect to the following items.

The Results Obtained are Shown in Table 1.

(1) Centerline Average Roughness Ra:

The surface roughness of the antireflection film was measured using an atomic force microscope (AFM) (SPI3800N, manufactured by Seiko Instruments Inc.).

(2) Haze:

The haze of the antireflection film was measured using a haze meter, MODEL 1001DP (manufactured by Nippon Denshoku Industries, Co., Ltd.).

(3) Transmitted Image Clarity:

The transmitted image clarity of the antireflection film was measured using a 0.5 mm-optical comb by an image clarity meter (ICM-2D Model) manufactured by Suga Test Instruments Co., Ltd.

(4) Integrated Reflectance:

The antireflection film was installed in an integrating sphere of a spectrophotometer, V-550 (manufactured by JASCO Corporation); an integrated reflectance was measured in a wavelength region of from 380 to 780 nm; and a mean integrated reflectance in the wavelength region of from 450 to 650 nm was calculated, thereby evaluating an antireflection ability.

(5) White Blurring:

A polarizing plate in the viewing side as provided in a liquid crystal display using a TN type liquid crystal cell (TH-15TA2, manufactured by Matsushita Electric Industrial Co., Ltd.) was peeled off; and in turn, each of the polarizing plates PA-01 to PA-17 was stuck via an adhesive in such a manner that the antireflection film side was placed in the viewing side that the transmission axis of the polarizing plate coincided with the polarizing plate stuck on the product. In a daylight room of 1,000 lux, the liquid crystal display was displayed black and visually evaluated from a variety of viewing angles according the following criteria.

Judgment Criteria of White Blurring

A: White blurring was not observed at all.

B: White blurring was not substantially observed.

C: Weak white blurring was observed.

D: Strong white blurring was observed.

(6) Intensity Ratio of Scattered Light by Goniophotometer:

Using a goniophotometer, GP-5 Model (manufactured by Murakami Color Research Laboratory), the antireflection film was aligned vertical against incident light, and a scattered light profile was measured over full orientations. The intensity of scattered light having an outgoing angle of 30° with respect to an intensity of light having an outgoing angle of 0° was determined.

(7) Right and Left Tint Change:

With respect to the liquid crystal display prepared above for the white blurring evaluation, when the viewing was inclined right and left, a degree of yellow coloration on white display was visually evaluated according to the following criteria.

Judgment Criteria of Right and Left Tint Change

A: Yellow coloration was not observed.

B: Yellow coloration was slightly observed.

C: Weak yellow coloration was observed.

D: Strong yellow coloration was observed.

(8) Viewing Angle:

With respect to the liquid crystal display prepared above for the white blurring evaluation, black display and white display were measured using an analyzer (EZ-Contrast 160D, manufactured by ELDIM), and the viewing angle of Contrast 10 was calculated.

(9) Steel Wool Abrasion Resistance:

A rubbing test was carried out using a rubbing tester under the following condition.

Condition of evaluation circumference: 25° C. and 60% RH

Rubbing material: A steel wool (No. 0000, manufactured by Nippon Steel Wool K.K.) was wound around a rubbing tip (1 cm×1 cm) of a tester coming into contact with the sample and band fixed such that it did not move.

Moving distance (one way): 13 cm, Rubbing speed: 13 cm/sec, Load: 500 g/cm², Contact area of tip: 1 cm×1 cm, Rubbing number: 10 reciprocations

An oily black ink was painted on the back side of the rubbed sample, and the abrasion in the rubbed portion was visually observed by reflected light and evaluated according to the following criteria.

A: Abrasion was not observed at all even by very careful observation.

B: Weak abrasion was observed.

C: Abrasion of a medium degree was observed.

D: Abrasion was observed at the first glance.

TABLE 1

| | | | Low refractive | | Intensity ratio of | | |
|---|---|---|---|---|---|---|---|
| | | Thickness of hard | index layer/ | | scattered light by | | Definition of |
| Antireflection film/ | | coat layer | Antireflection | Ra | goniophotometer | Haze | transmitted image |
| Polarizing plate | Hard coat layer | (μm) | layer | (μm) | (%) | (%) | (%) |
| A-01/PA-01 | 1 | 3.5 | 1 | 0.04 | 0.09 | 62 | 88 |
| A-02/PA-02 | 2 | 3.5 | 1 | 0.04 | 0.06 | 54 | 89 |
| A-03/PA-03 | 3 | 3.5 | 1 | 0.04 | 0.03 | 43 | 89 |
| A-04/PA-04 | 4 | 3.5 | 1 | 0.04 | 0.02 | 34 | 90 |
| A-05/PA-05 | 5 | 3.5 | 1 | 0.04 | 0.01 | 25 | 90 |
| A-06/PA-06 | 6 | 3.2 | 1 | 0.08 | 0.03 | 44 | 74 |
| A-07/PA-07 | 7 | 3.0 | 1 | 0.12 | 0.03 | 49 | 57 |
| A-08/PA-08 | 8 | 2.7 | 1 | 0.15 | 0.03 | 55 | 29 |
| A-09/PA-09 | 9 | 3.5 | 1 | 0.02 | 0.02 | 22 | 96 |
| A-10/PA-10 | 10 | 3.5 | 1 | 0.02 | 0.01 | 12 | 98 |
| A-11/PA-11 | 11 | 3.5 | 1 | 0.02 | 0.001 | 1 | 98 |
| A-12/PA-12 | 3 | 3.5 | 2 | 0.04 | 0.03 | 43 | 89 |
| A-13/PA-13 | 9 | 3.5 | 2 | 0.02 | 0.02 | 22 | 96 |
| A-14/PA-14 | 3 | 3.5 | 3 | 0.04 | 0.03 | 43 | 89 |
| A-15/PA-15 | 9 | 3.5 | 3 | 0.02 | 0.02 | 22 | 96 |
| A-16/PA-16 | 9 | 3.5 | No | 0.02 | 0.02 | 23 | 96 |
| A-17/PA-17 | 12 | 3.5 | 4 | 0.02 | 0.02 | 23 | 96 |

| | | | | Viewing angle | | |
|---|---|---|---|---|---|---|
| | Mean integrated | | | Up and low/ | | |
| Antireflection film/ | reflectance | | Right and left tint | Right and left | Abrasion | |
| Polarizing plate | (%) | White blurring | change | (degree) | resistance | Remark |
| A-01/PA-01 | 1.5 | A | A | 127/160 | A | Invention |
| A-02/PA-02 | 1.5 | A | A | 122/151 | A | Invention |
| A-03/PA-03 | 1.5 | A | A | 109/143 | A | Invention |
| A-04/PA-04 | 1.5 | A | B | 104/139 | A | Invention |
| A-05/PA-05 | 1.4 | A | C | 100/135 | A | Invention |
| A-06/PA-06 | 1.5 | B | A | 109/144 | A | Invention |
| A-07/PA-07 | 1.6 | C | A | 110/143 | A | Comparative Example |
| A-08/PA-08 | 1.8 | D | A | 109/144 | C | Comparative Example |
| A-09/PA-09 | 1.4 | A | A | 109/142 | A | Invention |
| A-10/PA-10 | 1.4 | A | A | 103/138 | A | Invention |
| A-11/PA-11 | 1.4 | A | D | 100/134 | A | Comparative Example |
| A-12/PA-12 | 2.1 | A | A | 109/143 | A | Comparative Example |
| A-13/PA-13 | 2.0 | A | A | 109/142 | A | Comparative Example |
| A-14/PA-14 | 1.7 | A | A | 109/143 | D | Comparative Example |
| A-15/PA-15 | 1.7 | A | A | 109/142 | D | Comparative Example |
| A-16/PA-16 | 5.7 | A | A | 109/142 | A | Comparative Example |
| A-17/PA-17 | 0.3 | A | A | 109/142 | B | Invention |

(Note)
The viewing angle is (contrast ratio) ≧ 10.
The term “4” in the “Low refractive index layer/Antireflection layer” column means a laminate of [medium refractive index later]/[high refractive index layer]/[low refractive index layer (coating solution A)].

From the results shown in Table 1, the following should be clear. That is, according to the antireflection film which comprises a hard coat layer containing a light-transmitting particle and having internal scattering properties and a low refractive index layer containing a hollow silica fine particle and has an Ra of not more than 0.10 μn, when used in a liquid crystal display, antireflection properties, white blurring, and viewing angle characteristics are improved in high levels. Further, by laminating medium/high/low refractive index layers and a multi-layered interference layer, extremely excellent antireflection properties are revealed.

Further, with respect to the antireflection films A-09, A-18 and A-19, the foregoing evaluation of steel wool abrasion resistance was carried out by changing the rubbing number to 20 reciprocations. As a result, A-18 and A-19 revealed superior results to A-09.

With respect to all of the antireflection films B-01 to B-19, the same results were obtained.

According to the invention, it is possible to provide an antireflection film which is prevented from glare of external light, is free from white blurring, image blurring and a glaring phenomenon, is able to enhance the visibility of displays such as liquid crystal displays, and is improved with respect to the abrasion resistance.

Also, the antireflection film of the invention can be used as a protective film of a polarizing plate. By using the antireflection film or polarizing plate of the invention in a liquid crystal display, it is possible to provide a liquid crystal display which has high visibility and enlarges a viewing angle, particularly, a downward viewing angle, so that a lowering of the contrast and changes in gradation, black-and-white reversion, hue, etc. caused by the change of viewing angle do not substantially occur.

The entire disclosure of each and every foreign patent application from which the benefit of foreign priority has been claimed in the present application is incorporated herein by reference, as if fully set forth.

1. An antireflection film comprising:
a first transparent support;
a low refractive index layer as an outermost layer; and
a hard coat layer between the first transparent support and the low refractive index layer,
wherein (i) the hard coat layer comprises a binder and light-transmitting particles, in which the binder and the light-transmitting particles have different refractive indexes;
(ii) the antireflection film has a centerline average roughness (Ra) of not more than 0.10 μm; and
(iii) the low refractive index layer comprises hollow silica fine particles having an average particle size of 5 to 200 nm and a refractive index of 1.15 to 1.40.

2. The antireflection film according to claim 1,
wherein at least one of the hard coat layer and the low refractive index layer comprises at least one of a hydrolysate of an organo silane compound and a partial condensate of an organo silane compound.

3. The antireflection film according to claim 1, which has a transmitted image clarity of 60% or more.

4. The antireflection film according to claim 1, which has a haze of 10% or more.

5. The antireflection film according to claim 1,
wherein the hard coat layer has a ratio of an intensity of a scattered light having an outgoing angle of 30° with respect to an intensity of a light having an outgoing angle of 0° in a scattered light profile measured by a goniophotometer, of from 0.01% to 0.2%.

6. The antireflection film according to claim 1, which has a mean integrated reflectance of not more than 1.5% in a wavelength of from 450 to 650 nm.

7. The antireflection film according to claim 1, which further comprises a high refractive index layer between the hard coat layer and the low refractive index layer,
wherein the high refractive index layer has a higher refractive index than the first transparent support.

8. The antireflection film according to claim 7, which further comprises a medium refractive index layer between the hard coat layer and the low refractive index layer,
wherein the medium refractive index layer has a higher refractive index than the low refractive index layer, and has a lower refractive index than the high refractive index layer,
wherein the medium refractive index layer has a higher refractive index than the first transparent support.

9. The antireflection film according to claim 8, which comprises the first transparent support; the hard coat layer; the medium refractive index layer; the high refractive index layer; and the low refractive index layer, in this order.

10. A polarizing plate comprising:
a first protective film;
a second protective film; and
a polarizing film between the first protective film and the second protective film,
wherein the first protective film is an antireflection film according to claim 1.

11. The polarizing plate according to claim 10,
wherein the first transparent support of the antireflection film is between the polarizing film and the low refractive index layer of the antireflection film.

12. The polarizing plate according to claim 10,
wherein the second protective film is an optical compensating film comprising:
a second transparent support; and
an optically anisotropic layer including a compound having a discotic structure unit,
wherein the discotic structure unit has a disc plane slanted to a plane of the second transparent support, and an angle between the disc plane and the plane of the second transparent support varies in a depth direction of the optically anisotropic layer.

13. The polarizing plate according to claim 12,
wherein the second transparent support is between the polarizing film and the optically anisotropic layer.

14. A liquid crystal display comprising an antireflection film according to claim 1 in the most superficial layer of the liquid crystal display.

15. A liquid crystal display comprising a polarizing plate according to claim 10 in the most superficial layer of the liquid crystal display.
